(19) United States
(12) Patent Application Publication
(10) Pub. No.: US 2010/0182234 A1
(43) Pub. Date: Jul. 22, 2010

(54) Projector System and Driving Method Thereof

(75) Inventors: Hiromasa Takahashi, Gamagori-shi (JP); Kazunari Taki, Nagoya-shi (JP); Hideo Ueno, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/748,958

(22) Filed: Mar. 29, 2010

Related U.S. Application Data
(63) Continuation-in-part of application No. PCT/JP2008/067448, filed on Sep. 26, 2008.

(30) Foreign Application Priority Data
Sep. 27, 2007 (JP) 2007-252679

(51) Int. Cl. G09G 5/08; G09G 5/00; G09G 5/10

(52) U.S. Cl. 345/157; 345/1.1; 345/690

(57) ABSTRACT

In a projector system which includes a plurality of projectors and a pointer, the projector generates instruction information and positional information based on a spot light radiated from the projector to a projection area of the projector, and transmits the instruction information and the positional information to another projector as processing information. One projector detects the spot light and transmits the processing information to another projector, and another projector detects the spot light. Both of a projection image which one projector projects and a projection image which another projector projects are associated with each other based on the processing information, and at least the projection image which one projector projects is changed.

### CROSS-REFERENCE TO RELATED APPLICATIONS

The present application is a Continuation-in-Part of International Application PCT/JP2008/067448 filed on Sep. 26, 2008, which claims the benefits of Japanese Patent Application No. 2007-252679 filed on Sep. 27, 2007.

### BACKGROUND

1. Field

The present invention relates to a projector system which projects an image on a projection surface such as a screen. The present invention relates more particularly to a projector system which simultaneously projects a plurality of projection images using a plurality of projectors, and moves or exchanges an image between the respective projection images using a pointer.

2. Description of the Related Art

Conventionally, a projector is used in a conference, a lecture or the like. Recently, particularly, to cope with the expansion of an amount of displaying information and the placement of more emphasis on an impression of a projection image to a viewer, a case where a plurality of projection images are simultaneously projected from a plurality of projectors has been increasing in number.

FIG. 24A and FIG. 24B schematically show a state where images are projected onto four projection surfaces M1 to M4 using four projectors PJ1 to PJ4. The respective projectors PJ1 to PJ4 are connected to a personal computer not shown in the drawing. Usually, the respective images which are projected onto four projection surfaces M1 to M4 are associated with each other. To arrange the respective projection images in an associated manner, it is necessary to arrange the projectors PJ1 to PJ4 in the predetermined order. Further, as shown in FIG. 24A, there may be a case where a projection image O which is projected onto the projection surface M2 by the projector PJ2 is moved to and is projected onto the projection surface M3 by the projector PJ3 as a projection image O′. Also in this case, it is necessary to arrange the projector PJ2 and the projector PJ3 in the predetermined order. When the projectors are not arranged in the predetermined order, for example, as shown in FIG. 24B, due to the change of the arrangement order of the projector PJ3 and the projector PJ4, the projection image O′ is projected onto the projection surface M4 and hence, the association among four projection images cannot be maintained.

Usually, the respective projectors PJ1 to PJ4 are formed using the same type of projector. Particularly, when the number of projectors is increased, the initial setting of positions of the projectors performed by an installer of such projectors becomes cumbersome. That is, it is necessary for the person who installs such projectors to arrange the respective projectors in the accurate order by repeating a series of operations where the respective projectors are temporarily installed, the projection images are projected onto the projection surfaces, and the person who installs such projectors changes the arrangement of the respective projectors while watching the projection images.

Further, there may be a case where one personal computer transmits image data to the projectors PJ1 to PJ4 so that projectors PJ1 to PJ4 project the associated projection images which are different from each other on the projection surfaces M1 to M4 respectively. In the initial setting performed in such a case, the personal computer transmits the different image data to four projectors PJ1 to PJ4 so as to allow the projectors PJ1 to PJ4 to project projection images on the projection surfaces M1 to M4. Next, a person who installs such projectors operates the personal computer so as to perform an operation which exchanges image data to be transmitted to the projectors PJ1 to PJ4. For example, in FIG. 24A, assume that four projectors PJ1 to PJ4 are installed in the order of the projectors PJ4, PJ3, PJ2, PJ1 from a left side so that the projection images to be projected onto the projection surfaces M1 to M4 are set in a laterally opposite arrangement. In this case, the person who installs such projectors, by operating a personal computer, changes over the image data transmitted to the projector PJ1 to the data transmitted to the projector PJ4, changes over the image data transmitted to the projector PJ2 to the data transmitted to the projector PJ3 and, thereafter, changes over the transmitted images sequentially hereinafter.

The above-mentioned setting of the initial arrangement of the projectors and the above-mentioned change of the arrangement of projection images using the personal computer are cumbersome and time-consuming. Particularly, when a person in charge of a conference or a lecture finds that the order of arrangement of projectors is wrong after the conference or the lecture starts, to correct the order of arrangement into the correct arrangement, it is necessary for him to interrupt the conference or the lecture and to ask an expert having a professional knowledge on projectors to make such correction of the order of arrangement.

There has been proposed a projector device which radiates a laser beam on a projection image projected onto a screen by a projector by operating a laser pointer so as to change the projection image. This projector device includes an image projection part which projects an image onto a projection surface, and an image inputting part which images the projected image and the laser beam radiated by the pointer. In such a projector device, a position to which the laser beam is radiated is detected in response to a result of imaging by the image inputting part, acquires image data associated with the position via a network or the like, and projects an image associated with the position onto a screen by the image projection part.

Further, there has been also proposed a technique in which a marker which becomes an adjustment reference is radiated to a projection image projected onto a screen by a projector body using a remote-controlled transmitter, the marker is detected by a detection sensor mounted on the projector body, and the inclination or the like of the projection image is adjusted using the marker as the reference.

### SUMMARY OF THE INVENTION

In projecting the plurality of projection images by the plurality of projectors, according to the above-mentioned technique, the initial setting of the projector is performed such that the installer of the projectors physically changes the arrangement of the projectors or the installer of the projectors changes the transmission destination of the image data to be transmitted to the projector while watching an operation screen of the personal computer. However, such operations are cumbersome, and there may be a case where it is difficult for a person who is not skilled in operating a computer to perform such changing of the arrangement of the projectors or such changing of image data transmission destination.

Particularly, when a speaker or a lecturer wants to change the arrangement of projection images or to move the projection images in the midst of the conference or the lecture after he projects the plurality of projection images using the plurality of projectors and starts the explanation, such a change or moving of the projection images requires time. As a result, the explanation by the speaker or the lecturer is interrupted so that audiences lose their interest in his speech or lecture. To obviate such a situation, it is necessary for an assistant who operates the computer to operate a computer following the intention of the speaker or the lecturer. Even in such a case, in many cases, it is difficult for the assistant to promptly cope with an unexpected change of the projection image or the like.

There has been also proposed a technique in which an operator radiates a laser beam to a projection image which a projector projects from a laser pointer, the projector detects a position or the like of the laser beam, and changes a projection image projected by the projector. That is, in this technique, the operator changes the projection image by operating the laser pointer while watching the projection image. However, this technique is directed to an operation of a signal projector, and is irrelevant to an operation where a projector detects a laser beam and changes a projection image projected by another projector.

To overcome the above-mentioned drawback, according to one aspect of the present invention, there is provided a projector system which includes: a plurality of projectors which are communicable with each other; and a pointer which, by radiating a spot light onto a projection area onto which a projection image is projected using the projector, gives an instruction relating to processing of the projection image. The projector includes: a spot light detection part; an instruction information generation part; and a transmission part. The spot light detection part detects the spot light radiated to the projection area of the projector. The instruction information generation part generates instruction information relating to processing of the projection image based on a detected spot light. The transmission part transmits processing information which contains the instruction information and identification information for specifying the projector. In the projector system having such a constitution, when one projector detects a spot light and, thereafter, another projector detects a spot light, a whole or a part of the projection image which one projector projects is projected by another projector based on the processing information.

To overcome the above-mentioned drawback, according to another aspect of the present invention, there is provided a driving method of a projector system which includes a plurality of projectors which are communicable with each other; and a pointer which gives instructions relating to processing of the projection image by radiating a spot light onto a projection area onto which a projection image is projected using the projector. In this driving method of a projector system, one projector detects the spot light radiated from the pointer, generates instruction information relating to processing of the projection image in response to the detection of the spot light from the pointer, and transmits the processing information. On the other hand, another projector detects the spot light radiated from the pointer, and projects+ a whole or a part of the projection image which one projector projects based on the processing information.

### BRIEF DESCRIPTION OF THE DRAWINGS

FIG. 1 is a schematic view showing a projector system according to an embodiment of the present invention;

FIG. 2 is a block diagram of a projector according to the embodiment of the present invention;

FIG. 3 is an appearance view of a pointer according to the embodiment of the present invention;

FIG. 4A to FIG. 4C are explanatory views expressing an operational example of the projector system according to the embodiment of the present invention;

FIG. 5A to FIG. 5C are explanatory views expressing an operational example of the projector system according to the embodiment of the present invention;

FIG. 6A to FIG. 6C are explanatory views expressing an operational example of the projector system according to the embodiment of the present invention;

FIG. 7A to FIG. 7C are explanatory views expressing an operational example of the projector system according to the embodiment of the present invention;

FIG. 8A to FIG. 8C are explanatory views expressing an operational example of the projector system according to the embodiment of the present invention;

FIG. 9A to FIG. 9C are explanatory views expressing an operational example of the projector system according to the embodiment of the present invention;

FIG. 10A to FIG. 10C are explanatory views expressing an operational example of the projector system according to the embodiment of the present invention;

FIG. 11A to FIG. 11D are explanatory views expressing an operational example of the projector system according to the embodiment of the present invention;

FIG. 12A to FIG. 12D are explanatory views expressing an operational example of the projector system according to the embodiment of the present invention;

FIG. 13A to FIG. 13D are explanatory views expressing an operational example of the projector system according to the embodiment of the present invention;

FIG. 14 is a flowchart of initial setting of a projector system according to the embodiment of the present invention;

FIG. 15 is a flowchart of an operation of a pointer according to the embodiment of the present invention;

FIG. 16A to FIG. 16B are flowcharts of a projector system according to the embodiment of the present invention;

FIG. 17 is an allocation table of the projection images in the projector system according to the embodiment of the present invention;

FIG. 18 is a flowchart of the projector system according to the embodiment of the present invention;

FIG. 19A to FIG. 19C are flowcharts of the projector system according to the embodiment of the present invention;

FIG. 20A to FIG. 20D are allocation tables of the projection images in the projector system according to the embodiment of the present invention;

FIG. 21A to FIG. 21B are flowcharts of the projector system according to the embodiment of the present invention;

FIG. 22 is a flowchart of the projector system according to the embodiment of the present invention;

FIG. 23A to FIG. 23B are flowcharts of the projector system according to the embodiment of the present invention; and

FIG. 24A and FIG. 24B are schematic views showing a conventionally known projector system.

### DETAILED DESCRIPTION

Hereinafter, an embodiment of the present invention is explained in detail in conjunction with attached drawings.

### <Overall Constitution of Projector System>

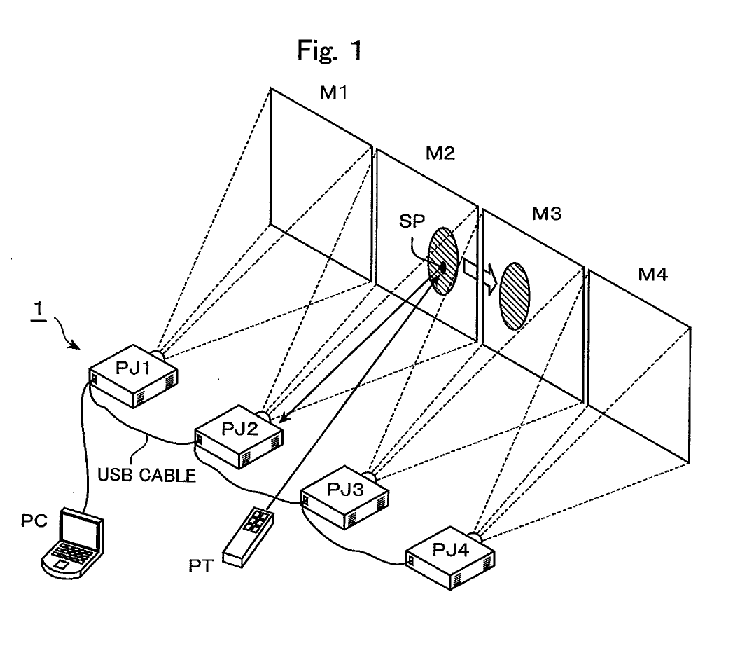

FIG. 1 is a schematic view of one embodiment of the present invention showing a state where projection images are projected onto respective projection surfaces M1 to M4 by projectors PJ1 to PJ4.

In FIG. 1, a projector system 1 is constituted of four projectors PJ1 to PJ4 and a pointer PT which radiates a laser beam. The projectors PJ1 to PJ4 project projection images onto the projection surfaces M1 to M4 respectively. The respective projectors PJ1 to PJ4 are connected to each other by USB cables. The projector PJ1 is connected to a personal computer (hereinafter referred to as PC) via a USB cable. The pointer PT designates a whole of the projection image or a part of the projection image by radiating a spot light SP to a projection image projected onto the projection surface. Here, the number of projectors to be connected to each other is not limited to four, and may be two or more. The projectors PJ1 to PJ4 may be communicable with each other through a LAN connection by wireless or by wire.

One example of an operation of the projector system 1 is explained. Firstly, the projector PJ1 is connected to the PC via the USB cable. The projector PJ1 which is connected to the PC constitutes a main projector (hereinafter, the projector PJ1 being referred to as a main projector). The projectors PJ2 to PJ4 constitute sub projectors. The main projector receives image data which the respective projectors PJ1 to PJ4 project from the PC and stores the image data in an image memory part thereof. The main projector transmits the image data on the projection images which the respective projectors project via the USB cable. Each sub projector which receives the image data projects a projection image based on the received image data on a projection surface of the projector.

A user allows the pointer PT to radiate a spot light SP to a projection image on the projection surface M2 and pushes a move button of the pointer PT. Then, the projector PJ2 which constitutes one projector detects the projection image projected onto the projection surface M2 and the spot light SP radiated by the pointer PT by a spot light detection part thereof. The projector PJ2 discriminates move instructions given to the spot light SP from the pointer PT, and generates instruction information indicative of move instructions by an instruction information generation part thereof. A transmission part of the projector PJ2 transmits the instruction information obtained by discrimination and identification information for identifying the projector PJ2 to the main projector as processing information.

Next, the user allows the pointer PT to radiate a spot light SP to a projection image on the projection surface M3 and pushes a move button of the pointer PT. Then, the projector PJ3 which constitutes another projector detects the projection image projected onto the projection surface M3 and the spot light SP radiated by the pointer PT by a spot light detection part thereof. The projector PJ3 discriminates move instructions given to the spot light SP from the pointer PT, and generates instruction information indicative of move instructions by instruction information generation part thereof. A transmission part of the projector PJ3 transmits the instruction information obtained by discrimination and identification information for identifying the projector PJ3 to the main projector as processing information.

The main projector receives processing information from the projectors PJ2, PJ3 by reception parts thereof. An image data processing part of the main projector adds or overwrites the image data for the projector PJ2 in the image data for the projector PJ3, and erases the image data which becomes a moving subject from the image data for the projector PJ2. Then, the transmission part of the main projector transmits the changed image data to the projectors PJ2 and PJ3. The projectors PJ2 and PJ3 receive such changed image data, and project the projection images to the projection surfaces M2 and M3 respectively. In this manner, the projection image projected on the projector PJ2 is moved to the projector PJ3. As a result, a user can easily change the projection image by operating the pointer without requiring a help of an assistant at the time of performing the initial setting of the projector or even after the user starts the explanation to audiences.

Heretofore, although the explanation has been made with respect to a case where the projection image is moved to the projector PJ3 from the projector PJ2, in the same manner, the user can perform the exchange of projection image or the copying of the projection image. That is, the user can exchange the projection image between the projection image of the projector PJ2 and the projection image of the projector PJ3, or the user can perform the copying of the projection image from the projector PJ2 to the projector PJ3 by leaving the projection image of the projector PJ2 as it is without erasing the projection image. Other projectors also function in the same manner. Further, besides the movement, the copying and the exchange of the projection image between two projectors, the user can rearrange the projection images to be projected by other projectors in the predetermined order or can designate the arrangement order using the projection image which the particular projector projects as the reference. Due to such operations, the projector system of this embodiment can enhance the user friendliness of the projector system in such a manner that when the user sets the arrangement of the projection images, it is no more necessary for him to physically move the arrangement of the projectors or to execute the processing of image data while watching an operation screen of the personal computer. For example, the user who performs the explanation to the audience using the projectors can simply and rapidly perform the exchange of the projection images during the explanation while watching the projection surfaces.

Further, in the above-mentioned case, the projection image is moved from the projector which is designated firstly by the pointer PT to the projector which is designated later by the pointer PT. However, the projection image may be moved from the projector which is later designated to the projector which is firstly designated.

Further, heretofore, the explanation has been made with respect to the case where the whole of the projection image is moved, exchanged or copied. However, instead of moving, exchanging or copying the whole of the projection image, a part of the projection image may be moved, exchanged or copied. By moving, exchanging or copying a part of the projection image, the user can acquire an advantageous effect that the user can easily move or exchange an image of a part of the projection image projected by each projector in response to the radiation of a spot light between the respective projectors. For example, the user can exchange a part of the projection image which the projector PJ2 projects and a part of the projection image which the projector PJ3 projects as follows.

The user radiates a spot light to a part of the projection image on the projection surface M2. Here, the spot light detection part of the projector PJ2 detects a spot light, and the position detection part of the projector PJ2 detects a position of the spot light within the projection area and generates positional information. The instruction information generation part of the projector PJ2 discriminates an instruction given by the pointer from the detected spot light, and generates instruction information. The transmission part of the projector PJ2 transmits the positional information, the instruction information and identification information for identifying the projector to the main projector as processing information.

Next, the user radiates a spot light to a part of the projection image on the projection surface M3. Here, in the same manner as the projector PJ2, the spot light detection part of the projector PJ3 detects a spot light, and the position detection part of the projector PJ3 detects a position of the spot light within the projection area and generates positional information. The instruction information generation part of the projector PJ3 discriminates an instruction given by the pointer from the detected spot light, and generates instruction information. The transmission part of the projector PJ3 transmits the positional information, the instruction information and identification information for identifying the projector to the main projector as processing information.

The main projector receives processing information from the projector PJ2 and the projector PJ3 respectively, and specifies respective objects of the projection images corresponding to the respective positional information. An image data processing part of the main projector moves the specified object from image data for the projector PJ2 to image data for the projector PJ3. This image data processing part also executes image data processing which moves the specified object from image data for the projector PJ3 to image data for the projector PJ2. The main projector transmits image data whose objects are exchanged to the projectors PJ2 and PJ3. The projectors PJ2 and PJ3 receive image data after exchange processing, and project the image data on the projection surfaces M2 and M3 respectively. In this manner, the above-mentioned projector system 1 can exchange a part of the projection images between the projectors.

Heretofore, the explanation has been made with respect to the case where the main projector executes the processing of image data in a state that the projectors are divided into the main projector and the sub projectors. In such a case, image data on the projection image which each projector projects is collectively controlled by the main projector thus giving rise to an advantageous effect that the image data can be simply exchanged or moved. In place of such image data processing, each projector may be configured to execute image data processing of the projection image of each own projector. For example, assume that the projector PJ2 which constitutes one projector detects a spot light by the spot light detection part thereof, and generates instruction information by the instruction information generation part thereof. In this case, the projector PJ2 transmits processing information which is constituted of the instruction information and identification information for identifying each projector to the projector PJ3. Next, the projector PJ3 detects a spot light, generates instruction information and transmits processing information constituted of the instruction information and identification information to the projector PJ2. Then, the projector PJ3 and the projector PJ2 exchange image data on designated projection images each other, and the respective projectors project the exchanged image data. By executing image data processing by imparting the substantially same functions to all projectors, the image data is transmitted and received between one projector and another projector. Accordingly, the projector system of this embodiment can acquire an advantageous effect that a communication data amount is reduced thus enhancing a processing speed at the time of changing the projection image.

### <Constitution of Projector>

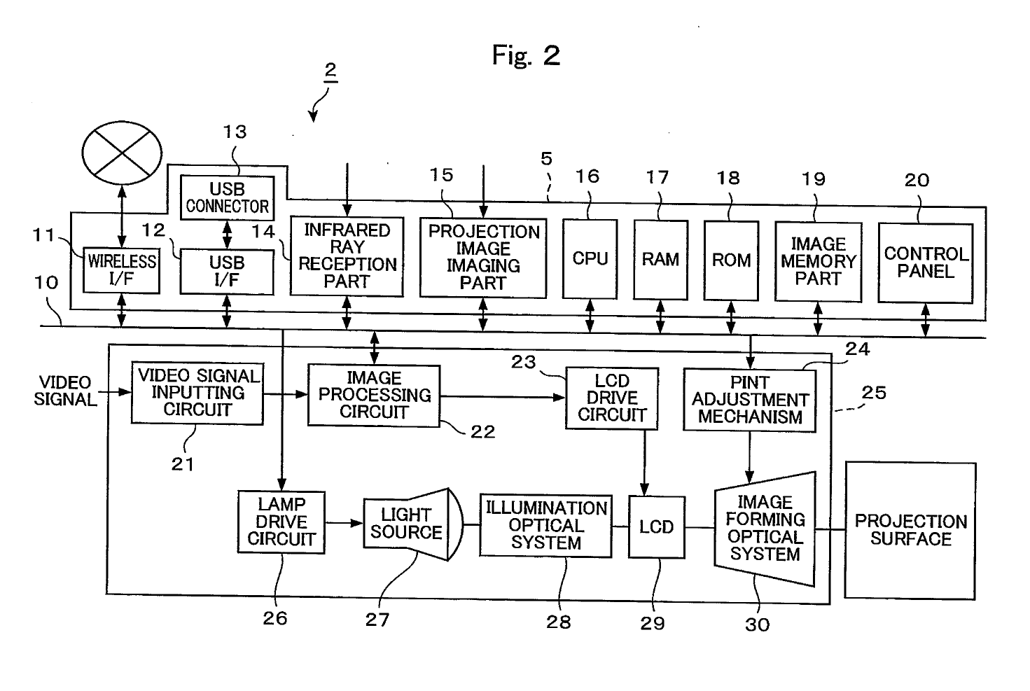

FIG. 2 is a block diagram of the projector 2 which constitutes the projector system according to the present invention. The projector 2 is constituted of a control part 5 which performs a control of the device and processing of data, and an image projection part 25 which visualizes image data and forms a projection image on a projection surface. The control part 5 includes a CPU 16, a ROM 18, a RAM 17, an image memory part 19, a control panel 20, a wireless I/F 11, a USB I/F 12, an infrared ray reception part 14, and a projection image imaging part 15. Here, the CPU 16 performs the control of the whole device and processing of image data by executing various programs. The ROM 18 stores a basic program, application programs and the like for operating the device. The RAM 17 stores an operation area which the CPU 16 uses in executing processing after reading various programs from the ROM 18. The image memory part 19 stores image data for forming the projection image. The control panel 20 allows the user to operate the projector 2. The wireless I/F 11 connects the projector to a network. The USB I/F 12 is connected to a USB connector 13 and performs transmission/reception of data such as image data. The infrared ray reception part 14 receives an infrared ray transmitted from the pointer PT. The projection image imaging part 15 images the projection image projected onto the projection surface and a spot light. These respective parts are connected to each other by a bus 10.

The image projection part 25 includes a video signal inputting circuit 21, an image processing circuit 22, an LCD drive circuit 23, an LCD 29, a light source 27, a lamp drive circuit 26, an illumination optical system 28, an image forming optical system 30, and a pint adjustment mechanism 24. Here, the video signal inputting circuit 21 receives a video signal from the outside. The image processing circuit 22 generates a display image signal from the inputted video signal and image data inputted through the bus 10. The LCD drive circuit 23 receives inputting of the display image signal from the image processing circuit 22 and generates a scanning signal and an image signal. An LCD 29 which receives the inputting of the scanning signal and the image signal from the LCD drive circuit 23 and visualizes these signals. The lamp drive circuit 26 controls light emission intensity of the light source 27. The illumination optical system 28 radiates light emitted from the light source 27 to the LCD 29. The image forming optical system 30 projects a display light from the LCD 29 on the projection surface in an enlarged manner. The pint adjustment mechanism 24 adjusts a focal point of the projection image projected from the image forming optical system 30.

The ROM 18 stores a main program, an application program, a spot light detection program, a position detection program, instruction information generation program, an object specifying program, a transmission/reception program and the like. Here, the main program is provided for performing a basic operation of the projector 2. The application program is provided for executing image data processing. The spot light detection program is provided for detecting a spot light from image data inputted from the projection image imaging part 15. The position detection program is provided for detecting a position within the projection area based on the detected spot light. The instruction information generation program is provided for generating instruction information by discriminating the instruction which the pointer PT gives from the detected spot light and the infrared ray reception part 14. The object specifying program is provided for specifying an object from the detected positional information and the image data on the projection image. The transmission/reception program is provided for transmitting or receiving image data and processing information through the USB I/F 12 and the wireless I/F 11. By reading these various programs into the RAM 17 and executing these programs, the CPU 16 functions as the control part, an application execution part, a spot light detection part, a position detection part, an instruction information generation part, an object specifying part, a transmission part and a reception part.

The projector 2 is intercommunicable with other projectors 2 through the wireless I/F and the USB I/F. When the projector 2 is operated as the main projector, image data on a projection image which each projector projects is received by the reception part through the wireless I/F or USB I/F and is stored in the image memory part 19. Then, preliminarily allocated image data is transmitted to each projector from the transmission part through the wireless I/F or the USB I/F. When a spot light is radiated to a projection area of another projector, the reception part receives processing information from such another projector 2 through the wireless I/F or the USB I/F, and the image data is processed in accordance with the processing information. The processed image data is transmitted to the image processing circuit 22 of another projector 2 or the own projector 2 through the transmission part and the wireless I/F or the USB I/F, and the image data is projected as the projection image. Here, the number of USB I/F corresponds to the number of connections necessary for connecting the projectors to each other.

The respective projectors 2 which constitute the projector system 1 have the substantially same functions and constitution. However, when the projector 2 is used as a sub projector, it is not always necessary for the projector to have the above-mentioned image processing part and the object specifying part.

### <Pointer>

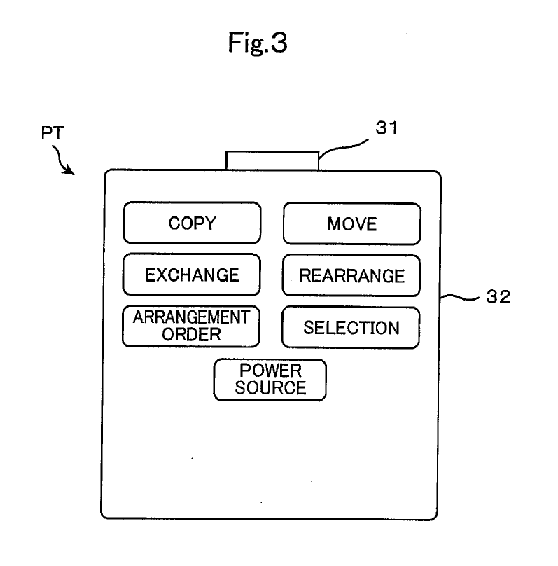

FIG. 3 is a schematic appearance view of the pointer PT which constitutes the projector system according to the present invention. On a housing 32 of the pointer PT, a laser beam radiation part 31, and respective selection buttons consisting of a “copy” button, a “move” button, an “exchange” button, a “rearrangement” button, an “arrangement order” button, a “selection” button and a “power source” button are mounted.

The “copy” button is provided for copying a whole or a part of a projection image which one projector projects onto a projection area of another projector. The “move” button is provided for moving a whole or a part of a projection image which one projector projects to a projection area of another projector.

The “exchange” button is provided for exchanging a whole or a part of a projection image which one projector projects with a whole or a part of a projection image of another projector.

The “rearrangement” button is provided for rearranging projection images of the respective projectors in a preliminarily determined order on projection surfaces on which other projectors project the projection images using a projection image of one projector as the reference. The “arrangement order” button is provided for projecting projection images of preliminarily determined order in accordance with a designated order by designating projection areas on which the respective projectors project. The “selection” button is provided for selecting a projection image which any one of projectors projects by designation. The “power source” button is provided for starting the pointer PT by turning on a power source of the pointer PT.

The pointer PT is constituted of a CPU which performs a control of the device, a memory part which stores a program, switches which are formed below respective buttons, a light emission part which emits a laser beam, a laser beam modulation part which imparts instructions to the laser beam, and a power source which supplies electricity to the respective parts. Due to such a constitution, the projector acquires an advantageous effect that it is unnecessary to newly provide a detection device which detects instruction information from the pointer. For example, by applying modulation of low frequency or high frequency to the spot light, an instruction relating to image processing is superimposed. The instruction information generation part of the projector demodulates the detected spot light thus generating instruction information. Accordingly, a user can simultaneously perform the selection of a projection image which the specified projector projects and the instructions relating to the processing of the projection image while watching the projection image. Accordingly, a user can acquire an advantageous effect that the user can extremely easily operate the projectors. The pointer PT may include, in place of the laser beam modulation part, an infrared ray emission part and an infrared ray modulation part for imparting instructions to the infrared ray. In this case, the projector system acquires an advantageous effect that the constitution of the spot light detection part can be simplified.

The user radiates a laser beam to a projection area of a projection surface onto which a projection image is projected by the projector thus displaying a spot light in the projection area. The user selects the projection area or an object by the spot light, and pushes a button. Then, a laser beam is modulated in response to the instruction given to the pushed button. The projection image imaging part 15 of the projector images the projection image and the spot light, and the spot light is detected by the spot light detection part. The instruction information generation part of the projector demodulates and discriminates the instruction given to the pushed button from the detected spot light, and generates instruction information. The position detection part of the projector generates positional information on the spot light based on the imaged projection image and the detected spot light. These instruction information and positional information are transmitted to another projector as processing information.

Due to such operations, the projector system of this embodiment can enhance the user friendliness of the projector system in such a manner that when the user sets the arrangement of the projection images, it is no more necessary for the user to physically move the arrangement of the projectors or to execute the processing of image data while watching an operation screen of the personal computer. For example, the user who performs the explanation to the audience using the projectors can simply and readily perform the exchange of the projection images during the explanation while watching the projection surfaces.

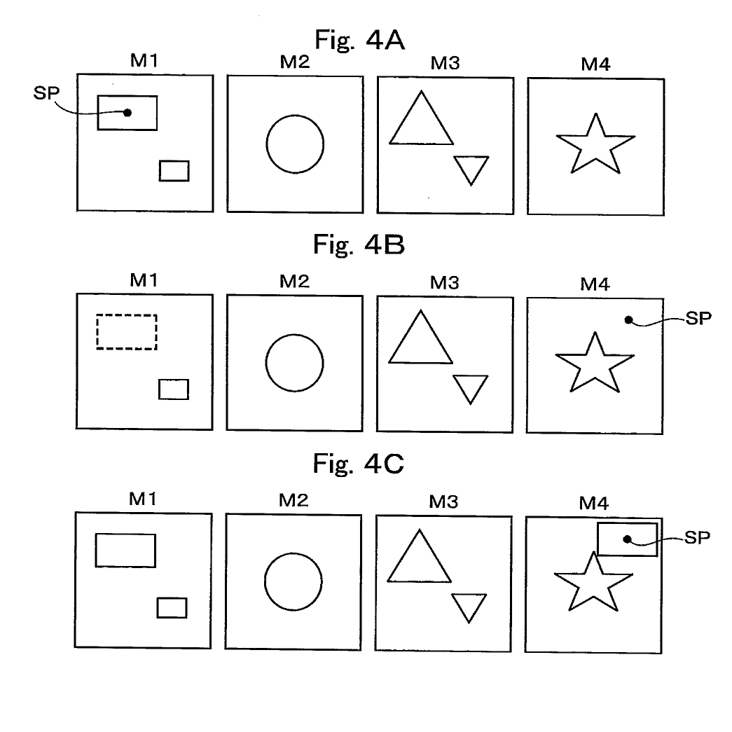

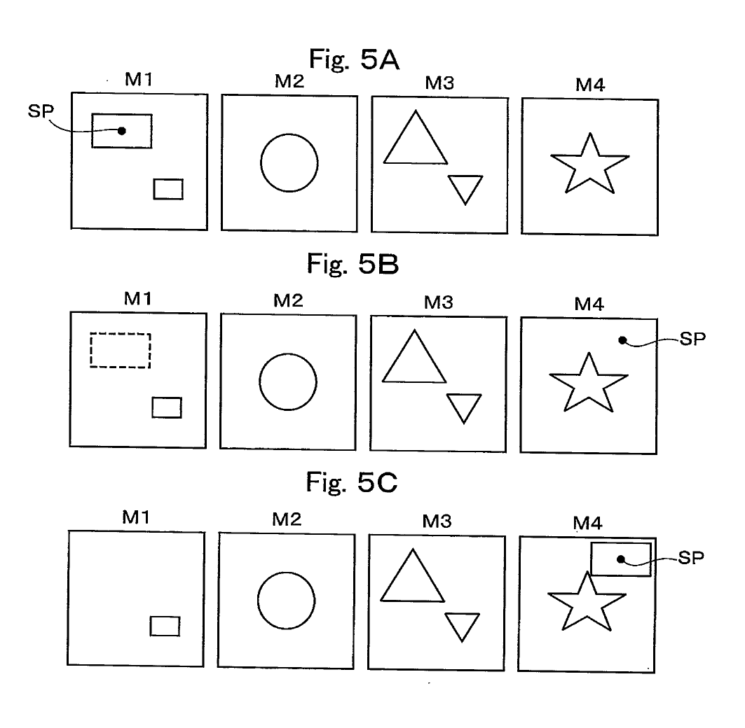

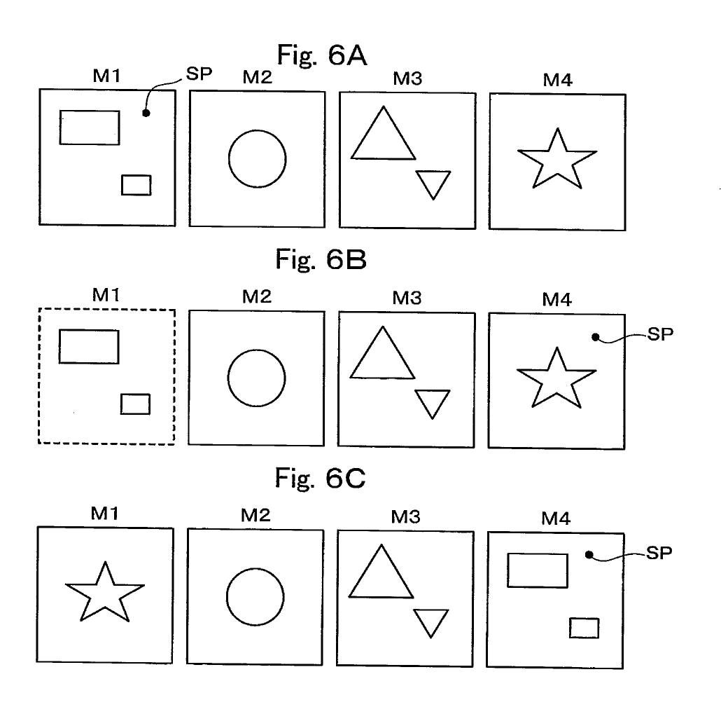

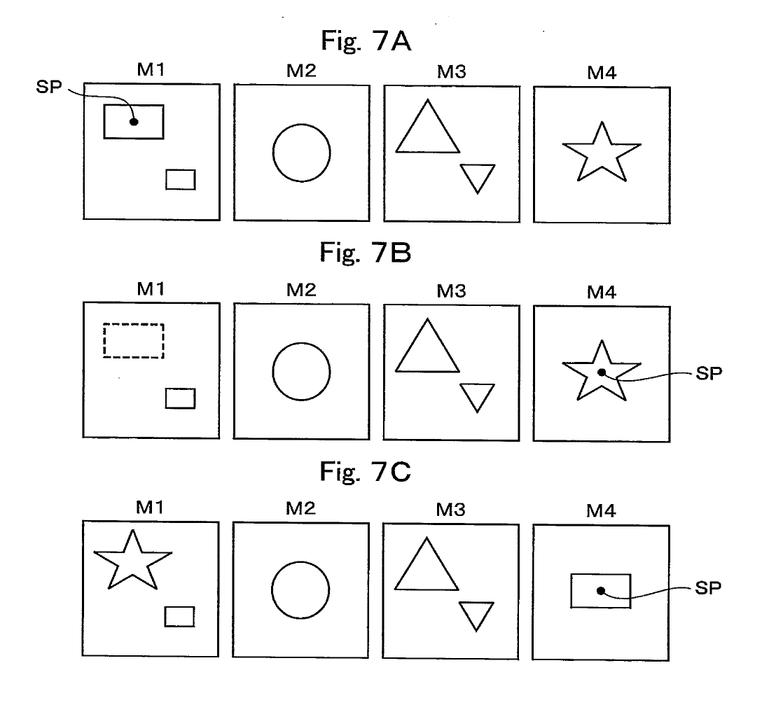

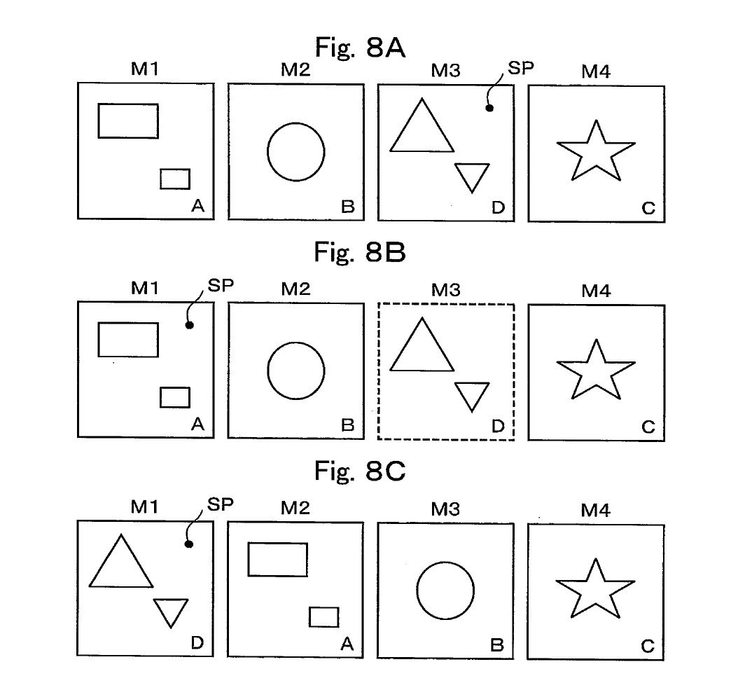

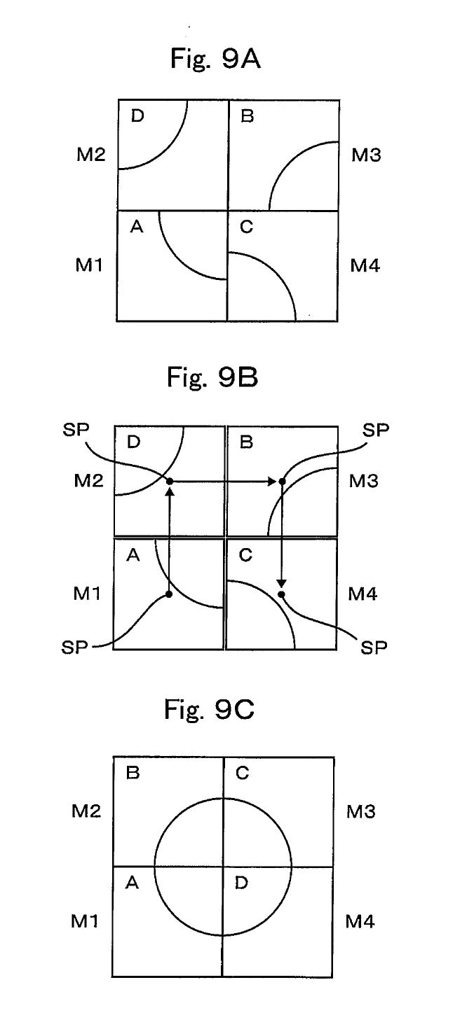

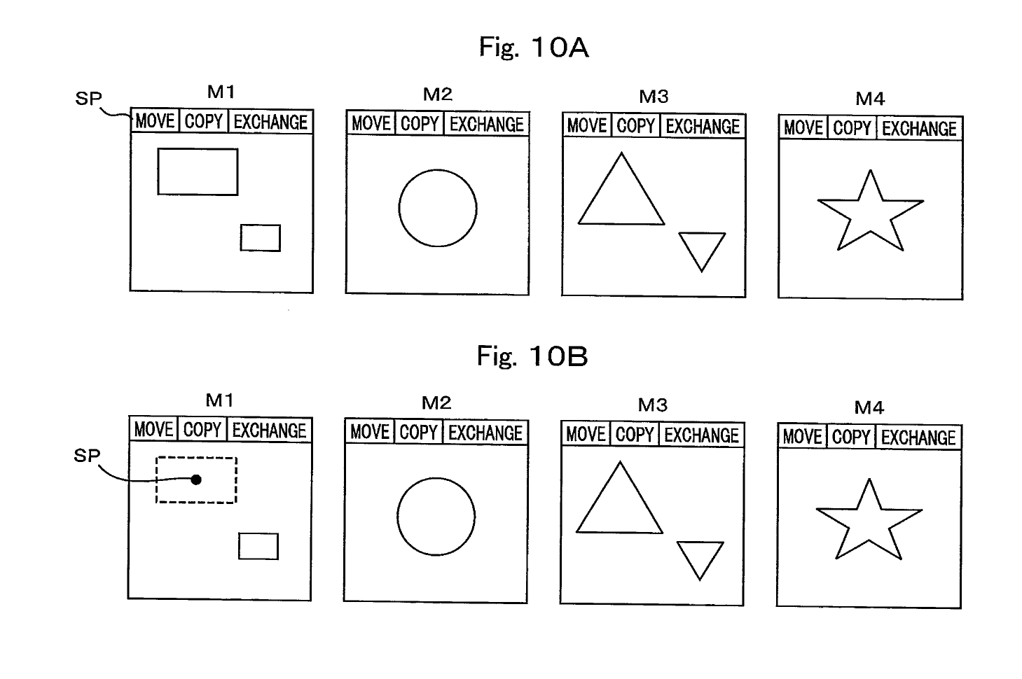

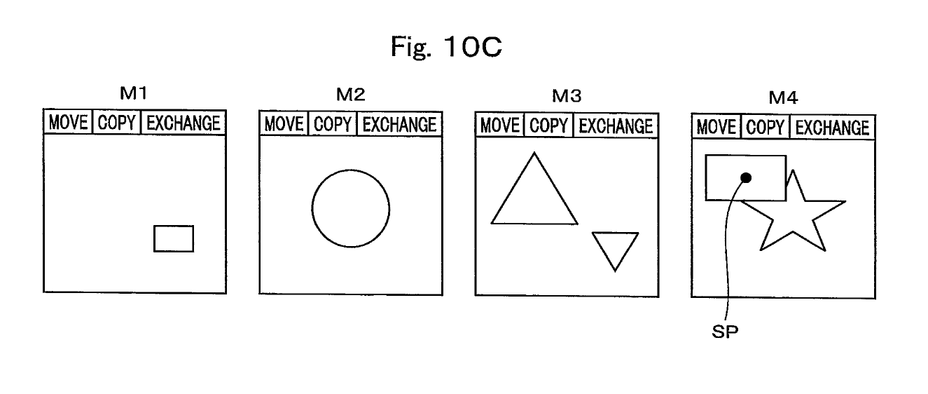

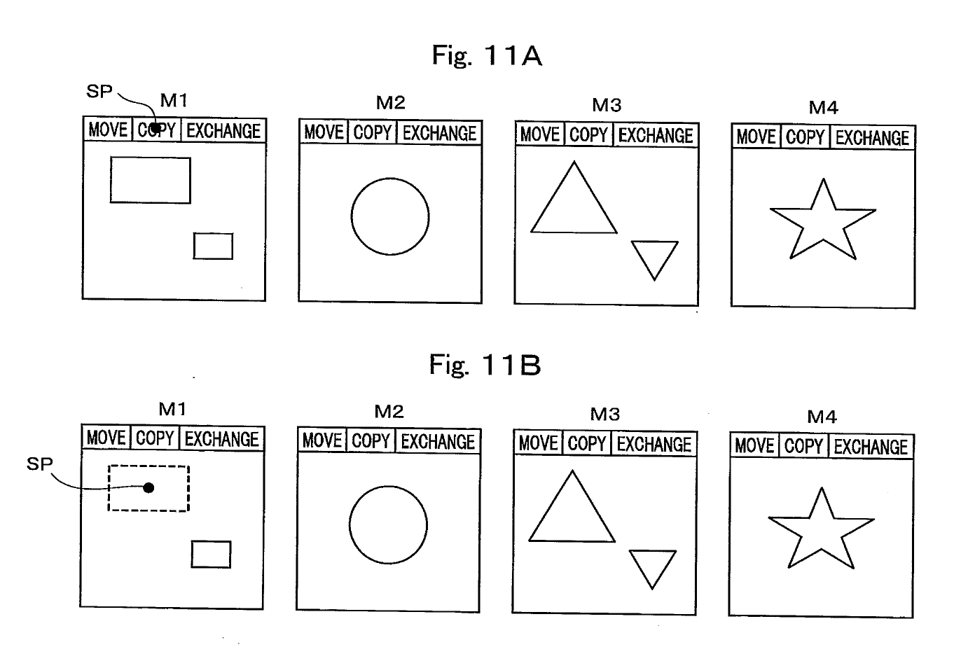

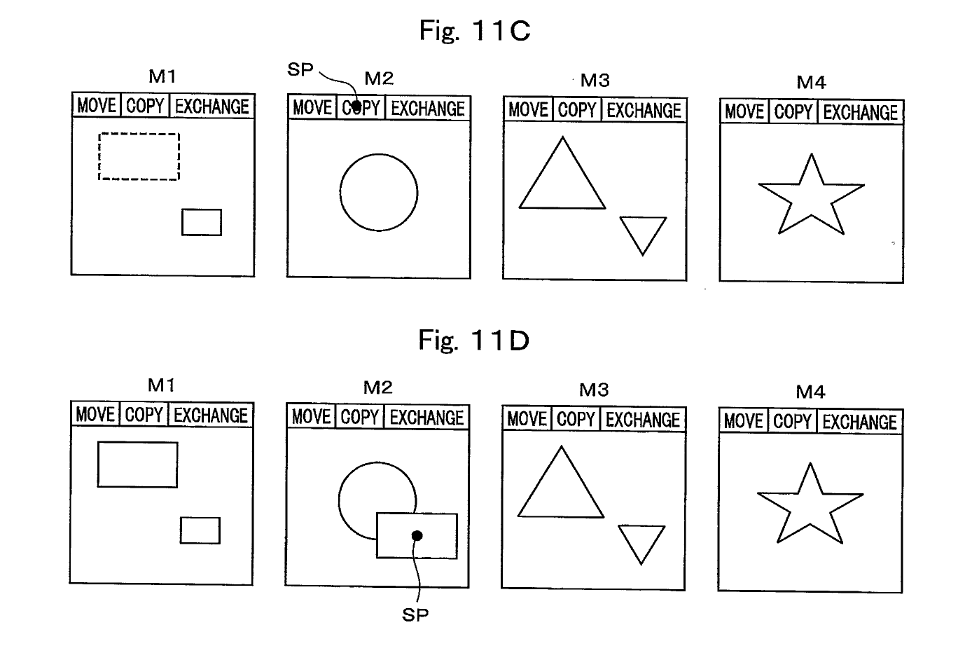

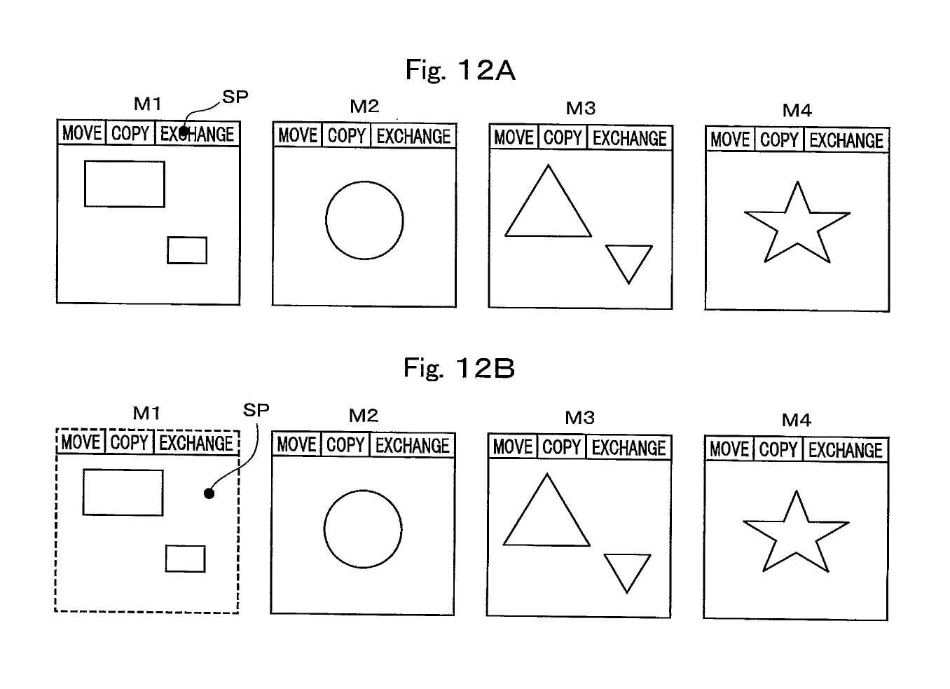

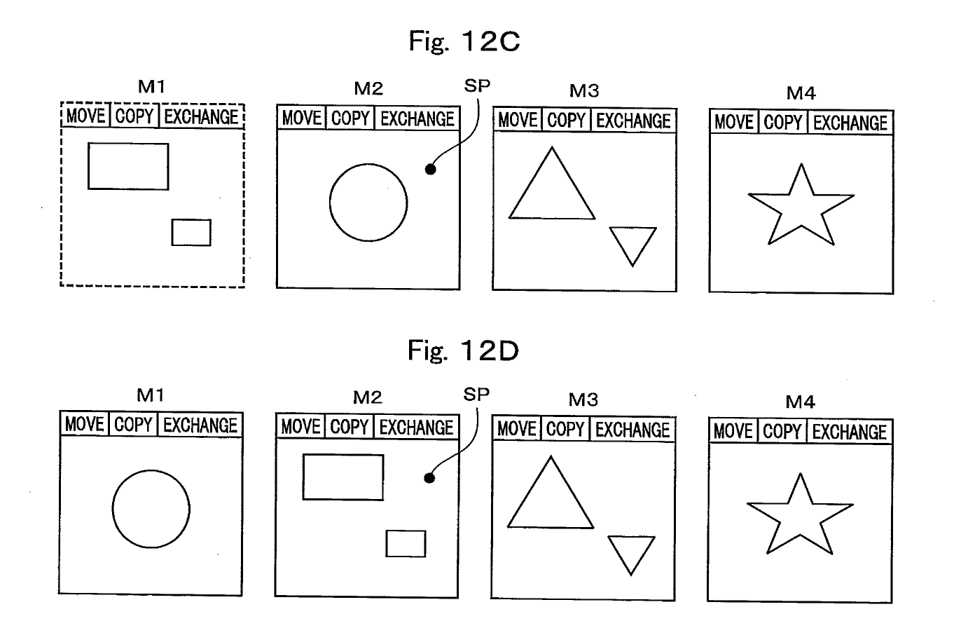

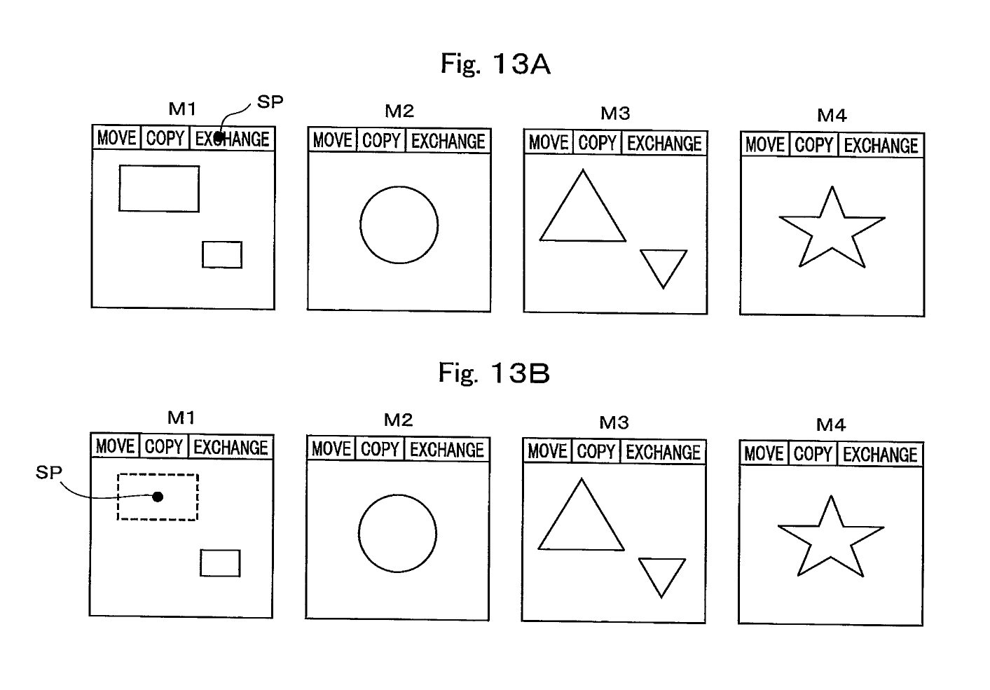

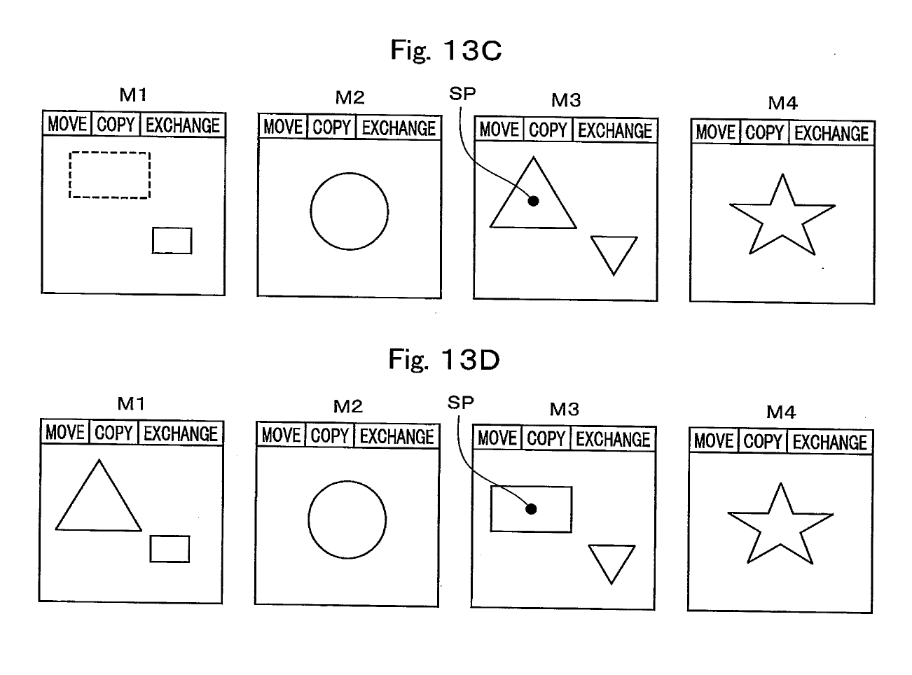

Next, the manner of operation of the projector system according to the present invention is explained specifically in conjunction with FIG. 4A to FIG. 13D. FIG. 4A to FIG. 13D show a state where projection images are projected onto the projection surfaces M1 to M4 by the projectors PJ1 to PJ4. FIG. 4A to FIG. 4C show steps of executing copying of an object. FIG. 5A to FIG. 5C show steps of executing movement of an object. FIG. 6A to FIG. 6C show steps of executing exchange of a projection image. FIG. 7A to FIG. 70 show steps of executing exchange of an object. FIG. 8A to FIG. 8C show steps of executing rearrangement of projection images. FIG. 9A to FIG. 9C show steps of executing designation of arrangement order. FIG. 10A to FIG. 10C show steps of executing movement of an object by selecting an instruction from a screen. FIG. 11A to FIG. 11D show steps of executing copying of an object by selecting an instruction on a screen. FIG. 12A to FIG. 12D show steps of executing exchange of a projection surface by selecting an instruction on a screen. FIG. 13A to FIG. 13D show steps of executing exchange of an object by selecting an instruction on a screen.

<Copying of object>

FIG. 4A to FIG. 4C show steps in which objects of the projection images are copied. FIG. 4A shows a state where a spot light SP is radiated to a left upper quadrangular shape of the projection image projected onto the projection surface M1, and a copy button of the pointer PT is pushed so that the left upper quadrangular shape is selected. FIG. 4B shows a state where the left upper quadrangular shape of the projection image on the projection surface M1 flickers so as to indicate the selection thereof, and a spot light SP is radiated to an empty space of the projection image projected onto the projection surface M4, and the copy button of the pointer PT is pushed. As a result, as shown in FIG. 4C, the left upper quadrangular shape of the projection image on the projection surface M1 is copied to a position on the projection surface M4 to which the spotlight SP is radiated. In this manner, the user can easily and rapidly copy an object which constitutes the projection image to the projector PJ4 from the projector PJ1 while watching the projection images. Accordingly, the user can easily and rapidly copy a whole or a part of the projection image over the projection images which two projectors PJ2, PJ3 project while watching the projection image.

In the above-mentioned embodiment, the explanation has been made with respect to the case where the projection image on the firstly selected projection surface is copied to the projection image on the later selected projection surface.

However, in place of such a copying order, the later selected projection image may be copied to the firstly selected projection image. Here, in both of the case where the firstly selected projection image is copied and the case where the later selected projection image is copied, the user pushes the copy button of the pointer PT. However, in place of such an operation, the user may push the selection button of the pointer PT one time and push the copy button one time before or after the pushing of the selection button such that a figure which is selected when the copy button is pushed is copied to a position of the spot light SP in the projection image designated by pushing the selection button.

### <Movement of Object>

FIG. 5A to FIG. 5C show steps in which objects of the projection images are moved. FIG. 5A shows a state where a spot light SP is radiated to a left upper quadrangular shape of the projection image projected onto the projection surface M1, and the move button of the pointer PT is pushed so that the left upper quadrangular shape is selected. FIG. 5B shows a state where the left upper quadrangular shape of the projection image on the projection surface M1 flickers so as to indicate the selection thereof, and a spot light SP is radiated to an empty space of the projection image projected onto the projection surface M4, and the move button of the pointer PT is pushed. As a result, as shown in FIG. 5C, the left upper quadrangular shape of the projection image on the projection surface M1 is moved to a position on the projection surface M4 to which the spot light SP is radiated, and the left upper quadrangular shape is erased from the projection image on the projection surface M1. Accordingly, the user can easily and rapidly move a whole or a part of the projection image over the projection images which two projectors PJ2, PJ3 project while watching the projection images.

Also in this embodiment, in the same manner as the above-mentioned copying of the object, the later selected projection image may be moved to the firstly selected projection image. Here, in both of the case where the firstly selected projection image is moved and the case where the later selected projection image is moved, the user pushes the move button of the pointer PT. However, in place of such an operation, the user may push the selection button one time and push the move button one time before or after the pushing of the selection button such that a figure which is selected when the move button is pushed is moved to a position of the spot light SP in the projection image designated by pushing the selection button.

### <Exchange of Screen>

FIG. 6A to FIG. 6C show steps in which two projection images which are projected onto the projection surfaces are exchanged. FIG. 6A shows a state where a spot light SP is radiated to an empty space of the projection image projected onto the projection surface M1, and the exchange button of the pointer PT is pushed. FIG. 6B shows a state where a periphery of the projection area on the projection surface M1 flickers so as to indicate the selection of the whole projection area, and a spot light SP is radiated to an empty space of the projection image projected onto the projection surface M4, and the exchange button of the pointer PT is pushed. As a result, as shown in FIG. 6C, the projection image on the projection surface M1 and the projection image on the projection surface M4 are exchanged. In this manner, the user can easily and rapidly exchange the projection image on the projection surface M1 and the projection image on the projection surface M4 while watching the projection images. Accordingly, the user can easily change projection positions of the projection images without physically moving the projectors even after the projectors are installed.

The above-mentioned selection of the projection image is performed by radiating the spot light SP to the empty space of the projection image. However, in place of such an operation or in addition to such an operation, the whole projection image may be selected by radiating a spot light SP to a frame portion of the projection image or a portion of the projection image in the vicinity of the frame portion. Also in this embodiment, in the same manner as the above-mentioned movement of the object, in both of the case where the firstly selected projection image is moved and the case where the later selected projection image is moved, the user pushes the exchange button of the pointer PT. However, in place of such an operation, the user may push the selection button of the pointer PT one time and push the exchange button one time before or after the pushing of the selection button such that the projection image is selected.

### <Exchange of Object>

FIG. 7A to FIG. 7C show steps in which objects of the projection images are exchanged. FIG. 7A shows a state where a spot light SP is radiated to a left upper quadrangular shape of the projection image projected onto the projection surface M1, and the exchange button of the pointer PT is pushed so that the left upper quadrangular shape is selected. FIG. 7B shows a state where the selected left upper quadrangular shape of the projection image on the projection surface M1 flickers so as to indicate the selection thereof, a spot light SP is radiated to a star-shaped image of the projection image projected onto the projection surface M4, and the exchange button of the pointer PT is pushed. As a result, as shown in FIG. 7C, the left upper quadrangular shape of the projection image on the projection surface M1 is moved to a position where the spot light SP is radiated to the projection surface M4, and the star-shaped image on the projection surface M4 is moved to a position on the projection surface M1 where the spot light SP is radiated. In this manner, the objects can be easily exchanged between two projection surfaces and hence, it is unnecessary for a user who explains the projection images to ask for a help of an assistant for operating the projection images.

Also in this embodiment, in the same manner as the above-mentioned movement of the object, in both of the case where the firstly selected projection image is exchanged and the case where the later selected projection image is exchanged, the user pushes the exchange button of the pointer PT. However, in place of such an operation, the use may push the selection button of the pointer PT one time and push the exchange button one time before or after the pushing of the selection button.

In this case, a figure which is selected when the user pushes the exchange button is moved to a position of the spot light SP in the projection image designated by the user by pushing the selection button so that the objects are exchanged.

### <Rearrangement of Screens>

FIG. 8A to FIG. 8C show steps in which the rearrangement of projection screens is performed. The order is preliminarily allocated to the respective projection images in order of projection surfaces M1, M2, M3 and M4. FIG. 8A shows a state where a spot light SP is radiated to an empty space of a projection image projected onto the projection surface M3, and the rearrangement button of the pointer PT is pushed. FIG. 8B shows a state where a periphery of a projection area on the projection surface M3 flickers so as to indicate the selection of the whole projection area, a spot light SP is radiated to the projection surface M1, and the rearrangement button of the pointer PT is pushed. As a result, as shown in FIG. 8C, the projection image projected onto the projection surface M3 is moved to the projection surface M1, and an image A and an image B are moved to the projection surfaces M2, M3 in the preliminarily allocated order. That is, the image A on the projection surface M1 is moved to the projection surface M2, and the image B on the projection surface M2 is moved to the projection surface M3. Accordingly, a user can simply and rapidly change the arrangement order of the projection images without performing a cumbersome operation where a user changes a physical arrangement of the respective projectors or changes setting of projection images which the respective projectors project while watching a screen of the personal computer.

Also in this embodiment, in selecting the projection image later, the user may push the selection button in place of pushing the rearrangement button of the pointer PT. This is because when the selection button is pushed in selecting the projection image later, a projection position on the projection surface to which the projection image is moved is determined.

### <Arrangement Order of Screens>

FIG. 9A to FIG. 9C show steps of designating arrangement order of screens. The order is preliminarily allocated to the respective projection images in order of images A, B, C and D. In FIG. 9A, the projection surfaces M1 to M4 are arranged in a quadrangular shape. The image A is projected onto the projection surface M1, the image D is projected onto the projection surface M2, the image B is projected onto the projection surface M3, and the image C is projected onto the projection surface M4. FIG. 9B shows a state where a spot light SP is sequentially radiated to the projection surfaces M1, M2, M3 and M4 in this order, and the arrangement order button of the pointer PT is pushed when the spot light SP is radiated to each projection surface. As a result, as shown in FIG. 9C, the image A is projected onto the firstly selected projection surface M1, the image B which is designated as the second in order is projected onto the secondly selected projection surface M2, the image C which is designated as the third in order is projected onto the thirdly selected projection surface M3, and the image D which is designated as the fourth in order is projected onto the fourthly selected projection surface M4. By making use of such a function, a user can rapidly rearrange the projection images projected from the respective projectors to arbitrary positions. As a result, the user can extremely simply perform the initial setting of the projectors. Accordingly, the user can simply and rapidly change the arrangement order of the projection images without performing a cumbersome operation where the user changes the physical arrangement of the respective projectors or changes setting of the projection images which the respective projectors project while watching a screen of the personal computer.

<Move objects by giving instructions from projection screens>

FIG. 10A to FIG. 10C show steps in which an object is moved by selecting instructions given to the projector from a processing instructions screen projected onto the projection surface. The processing instructions screen which allows the selection of processing with the pointer is projected onto an upper portion of the projection image on each projection surface M1, M2, M3, M4. FIG. 10A shows a state where a spot light SP is radiated to an area “move” of the processing instructions screen projected onto the projection surface M1 for a predetermined time, for example, 0.5 seconds to several seconds.

When such a state is established, the projector PJ1 discriminates that the instruction from the pointer PT is movement, and flickers characters “move” or a frame of the characters. FIG. 10B shows a state where a spot light SP is radiated to a left upper quadrangular shape of the projection image on the projection surface M1 for a predetermined time. When such a state is established, the projector PJ1 discriminates a moving object, and flickers the object. FIG. 10C shows a state where a spot light SP is radiated to a projection area on the projection surface M4 for a predetermined time. When such a state is established, a state where the projector PJ4 is selected and a moved position of the object are discriminated. Then, the quadrangular object projected onto a left upper portion on the projection surface M1 is moved to a position on the projection surface M4 where the spot light SP is radiated.

The above-mentioned steps bring about an advantageous effect that by radiating a spot light to a specified area within the projection image while watching the projection image, the user can input specified information to the projector in the same manner as a pointing device formed of a mouse of the personal computer or the like. It is no more necessary for the user to shift his eyes from the projection image when he operates the projection image. The same goes for “copy” processing and “exchange” processing explained hereinafter.

Since the instructions on image processing can be selected using the projection image screen as described above, it is sufficient for the pointer PT to have a function of flickering a spot light SP. Accordingly, the constitution of the pointer PT can be simplified. In the above-mentioned embodiment, in moving the object of the projection image, the movement is selected by radiating the spot light SP to the “move” area of the processing instructions screen for a predetermined time. However, in place of such an operation, by providing an area for executing processing on the processing instructions screen, for example, an “execution” area, a “selection” area or the like, the user can execute such processing by radiating the spot light SP to such an area. Further, the user can also execute processing by pushing a selection button of the pointer using an infrared ray emission part mounted on the pointer PT. The same goes for the processing described hereinafter.

<Copy Objects by Giving Instructions from Projection Screens>

FIG. 11A to FIG. 11D show steps in which an object is copied by selecting instructions given to the projector from a processing instructions screen projected onto the projection surface. FIG. 11A shows a state where a spot light SP is radiated to an area “copy” on the processing instructions screen projected onto the projection surface M1 for a predetermined time. When such a state is established, the projector PJ1 discriminates that the instructions from the pointer PT is copying, and flickers characters “copy” or a frame of the characters. FIG. 11B shows a state where the spot light SP is radiated to a left upper quadrangular shape of the projection image on the projection surface M1 for a predetermined time. When such a state is established, the projector PJ1 discriminates an object to be copied, and flickers the object.

FIG. 11C shows a state where a spot light SP is radiated to an area “copy” on the processing instructions screen projected onto the projection surface M2 for a predetermined time. When such a state is established, the projector PJ2 discriminates that the instruction from the pointer PT is copy, and flickers characters “copy” or a frame of the characters. FIG. 11D shows a state where a spot light SP is radiated to a projection area of the projection surface M2 for a predetermined time. When such a state is established, the object of the left upper quadrangular shape on the projection surface M1 is copied to a position on the projection surface M2 to which the spot light SP is radiated.

In the above-mentioned embodiment, the step shown in FIG. 11C can be omitted. This is because it is discriminated that the object of the left upper quadrangular shape selected on the projection surface M1 is expected to be copied and hence, the position of the copying destination can be specified by radiating the spot light on the projection area on the projection surface M2.

<Exchange Screens by Giving Instructions from Projection Screens>

FIG. 12A to FIG. 12D show steps in which projection screens are exchanged by selecting instructions given to the projectors from processing instruction screens projected onto the projection surfaces. FIG. 12A shows a state where a spot light SP is radiated to an area “exchange” on the processing instructions screen projected onto the projection surface M1 for a predetermined time. When such a state is established, the projector PJ1 discriminates that the instruction from the pointer PT is exchange, and flickers characters “exchange” or a frame of the characters. FIG. 12B shows a state where the spot light SP is radiated to an empty space of the projection image projected onto the projection surface M1 for a predetermined time. When such a state is established, the projector PJ1 discriminates that the instruction requests the exchange of the whole projection image, and flickers the projection image or a projection area frame. FIG. 12C shows a state where a spot light SP is radiated to the projection area projected onto the projection surface M2. When the spot light SP is radiated to the projection surface M2 for a predetermined time, as shown in FIG. 12D, the whole projection image on the projection surface M1 and the whole projection image on the projection surface M2 are exchanged.

<Exchange Objects by Giving Instructions from Projection Screens>

FIG. 13A to FIG. 13D show steps in which objects are exchanged by selecting instructions given to the projectors from processing instruction screens projected onto the projection surfaces. FIG. 13A shows a state where a spot light SP is radiated to an area “exchange” on the processing instructions screen projected onto the projection surface M1 for a predetermined time. When such a state is established, the projector PJ1 discriminates that the instruction from the pointer PT is exchange, and flickers characters “exchange” or a frame of the characters. FIG. 13B shows a state where the spot light SP is radiated to a left upper quadrangular area of the projection image projected onto the projection surface M1 for a predetermined time. When such a state is established, the projector PJ1 discriminates that the instruction requests the exchange of the left upper quadrangular object, and flickers the quadrangular shape. FIG. 13C shows a state where a spot light SP is radiated to a left upper triangular shape of the projection image projected onto the projection surface M3.

Here, the left upper quadrangular shape on the projection surface which is the exchange source flickers. By radiating the spot light SP to the area on the projection surface M3 for a predetermined time, as shown in FIG. 13D, the left upper quadrangular shape on the projection surface M1 and the left upper triangular shape on the projection surface M3 are exchanged.

In FIG. 10A to FIG. 13D, only the movement, copying and the exchange of the objects are explained in giving instructions to the projectors from the processing instructions screen.

However, kinds of processing are not limited to these processing. By providing selection areas “rearrange” and “arrangement order” on the processing instructions screen and allowing the user to select these instructions, the user can perform the same operations as explained in conjunction with FIG. 8 and FIG. 9. Further, to differentiate the selection of the whole projection image and the selection of the partial projection image from each other, colors of the selected images may be changed or a contrast between the selected images may be changed. Further, in designating an object of a projection image, a user may designate a plurality of objects and may perform copy move, exchange or the like collectively.

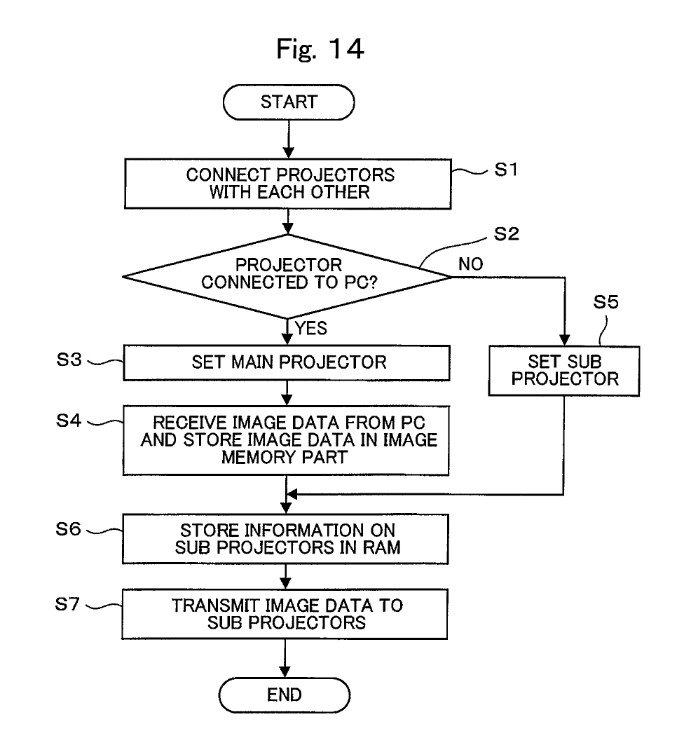

Next, embodiments of an operation flow according to the projector system 1 are explained using flowcharts and tables for allocating projection images shown in FIG. 14 to FIG. 23B.

<Initial setting of projectors>

FIG. 14 shows a flowchart of initial setting of the main projector and the sub projectors. Firstly, when the respective projectors are connected to each other using the USB cable, the projectors are mutually connected to each other thus allowing the communication among the projectors (step S1). Any one of the projectors is connected to the PC (personal computer). The projector to which the PC is connected recognizes the connection thereof with the PC (step S2: Yes), and sets itself as the main projector (step S3). The projector to which the PC is not connected (step S2: No) sets itself as the sub projector (step 55).

In the main projector, the CPU 16 reads various programs stored in the ROM 18 and stores these programs in the RAM 17 and, then, reads the programs from the RAM 17 and executes the programs thus functioning as the spot light detection part, the instruction information generation part, the position detection part, the image data processing part, the object specifying part, the transmission/reception part and the like. In the sub projectors, the CPU 16 reads various programs stored in the ROM 18 and stores these programs in the RAM 17 and, then, reads the programs from the RAM 17 and executes the programs thus functioning as the spot light detection part, the instruction information generation part, the position detection part, the transmission/reception part and the like.

The image data processing part of the main projector receives image data from the PC and stores the image data in the image memory part 19 (step S4). The control part 5 of the main projector receives identification information for identifying the sub projectors and the like from the sub projectors, and stores the identification information and the like in the RAM 17 (step S6). The image data processing part of the main projector transmits image data on the projection images which the sub projectors project to the respective sub projectors based on the acquired identification information (step S7) thus finishing the initial setting.

In the above-mentioned embodiment, the projector 2 which is connected to the PC is set as the main projector, and the projectors 2 which are not connected to the PC are set as the sub projectors. However, the present invention is not limited to such an embodiment. For example, the main projector and the sub projectors may be manually set by operating the control panel 20 of each projector 2. Further, in place of the constitution of the projector system where the image data which the respective projectors 2 project is received from the PC, the main projector may store image data which the respective projectors project in the image memory part 19 and may deliver the image data to the sub projectors. Alternatively, each sub projector may store image data in the image memory part 19 thereof, and transmits the stored image data to the main projector thus allowing the main projector to perform the centralized administration.

### <Operation Flow of Pointer>

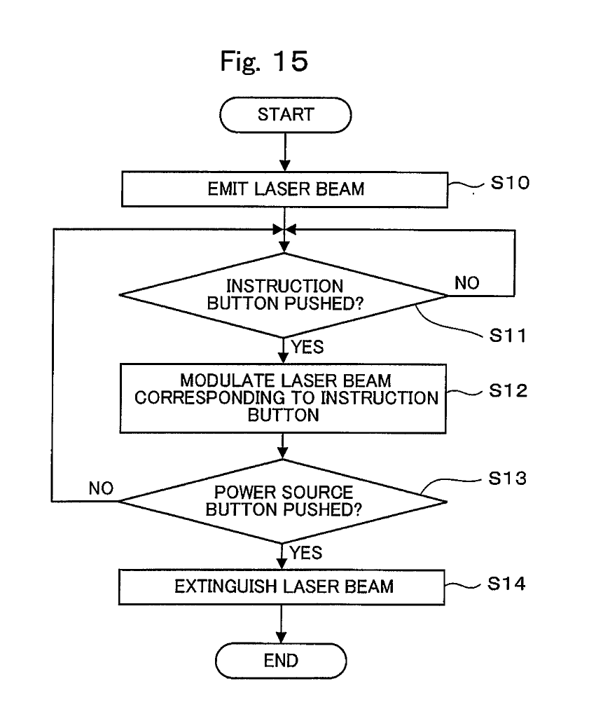

The manner of operation of the pointer PT is explained in conjunction with FIG. 15. A light emission part of the pointer PT emits a laser beam when a user pushes the power source button, and the laser beam is radiated from a laser beam radiation part 31 (step S10). By pushing any one of the instruction buttons such as the copy button (step S11: Yes), a laser beam modulation part performs the modulation of the laser beam corresponding to the instruction button (step S12). When the instruction button is not pushed (step S11: No), the pointer PT assumes a standby state. Also when the power source button is not pushed (step S13: No), the CPU 16 returns the processing to step S11 and the pointer PT assumes a standby state. When the user pushes the power source button (step S13: Yes), the laser beam is extinguished (step S14) and the operation of the pointer PT is finished.

To be more specific, the pointer PT is operated as follows. For example, when the whole or a part of the projection image is copied from one projector to another projector, the user pushes the power source button of the pointer PT so as to allow the pointer PT to radiate a laser beam from the laser beam radiation part 31. The user selects an object which constitutes a portion of the projection image projected onto the projection surface of the copying source, and pushes the copy button. When the copy button is pushed, the pointer PT modulates the laser beam and gives the copy instruction. Then, the selected object flickers so as to indicate the selection of the object. Next, the user indicates the position where the object is expected to be copied by radiating the laser beam to the projection surface of the copying destination, and pushes the copy button of the pointer PT. Accordingly, the selected object of the copying source is copied to the position on the projection surface of the copying destination designated by the spot light which is a laser beam.

Although the manner of copying the object has been explained above, the designation of the movement, the exchange, the rearrangement and the arrangement order of the object can also be performed in the same manner. Further, the operation such as the movement, the exchange, the rearrangement or the arrangement order is not limited to the object and the operation such as copy, move, exchange or the like may also be applied to the whole projection screen. Further, as shown in FIG. 10 to FIG. 13, when various instructions are selected from the processing instructions screen of the projection image, the instruction information may be inputted to the projector by radiating the spot light to the area “copy” on the processing instructions screen for a predetermined time.

### <Operation Flow of Projectors (Processing of Whole Screens)>

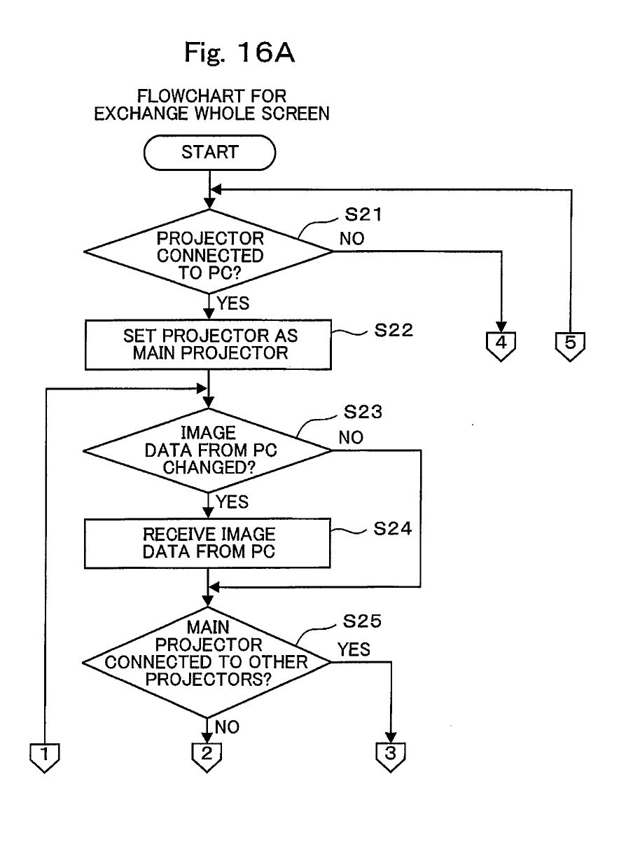

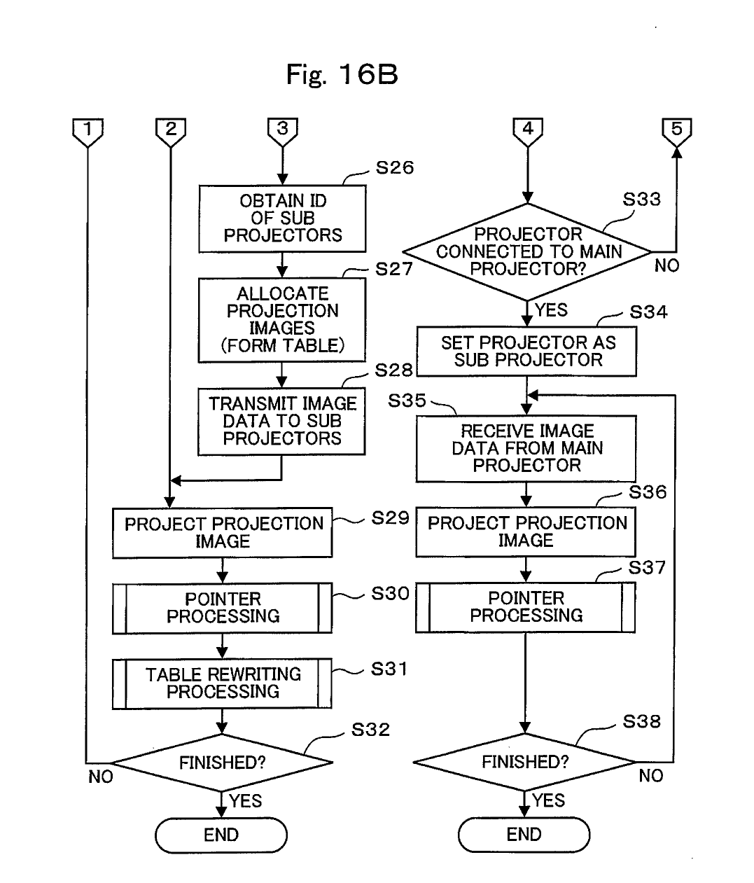

FIG. 16A to FIG. 16B are flowcharts showing an operation mode of an operation of the projector when the exchange of the projection image or the like is performed. As shown in FIG. 16A, the control part of the projector detects whether or not the projector is connected to the PC (step S21). When the control part of the projector determines that the projector is connected to the PC (step S21: Yes), the control part of the projector sets own projector as the main projector (step S22). The control part of the main projector detects whether or not an image data from the PC to which the main projector is connected is changed from the image data stored in the image memory part 19 thereof (step S23). When the control part of the main projector detects that the image data from the PC is changed from the image data stored in the image memory part 19 (step S23: Yes), the control part of the main projector receives the image data from the PC through the reception part, and stores the image data in the image memory part 19 as image data to be projected (step S24). When the control part of the main projector detects that the image data from the PC is not changed from the image data stored in the image memory part 19 (step S23: No), the control part of the main projector advances the processing to next step S25.

The control part of the main projector detects whether or not the main projector is connected to other projectors (step S25). When the control part of the main projector detects that the projector connected to the main projector is present (step S25: Yes), the control part of the main projector obtains identification information (hereinafter referred to as ID) of the sub projector through the reception part (step S26) (see FIG. 16B). The control part of the main projector forms a table for allocating projection images which the main projector and the sub projectors project (step S27).

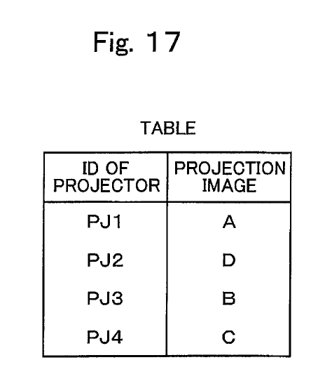

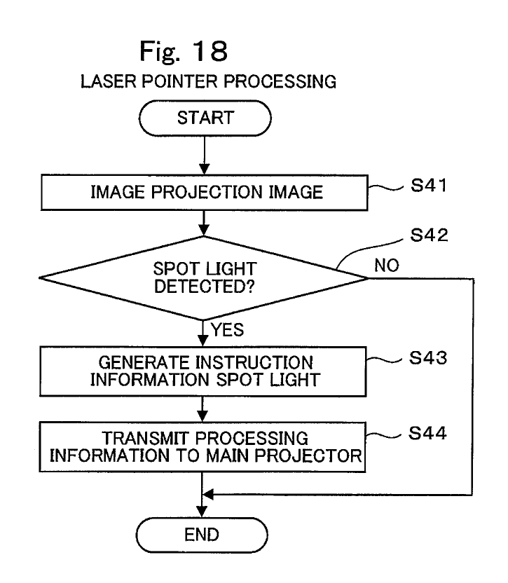

FIG. 17 shows one example of the table which the main projector forms in the RAM 17 of the main projector. For example, when the ID of the projector is PJ1, a projection image A is allocated to the projector with the PJ1 ID, when the ID of the projector is PJ2, a projection image D is allocated to the projector with the PJ2 ID, when the ID of the projector is PJ3, a projection image B is allocated to the projector with the PJ3 ID, and when the ID of the projector is PJ4, a projection image C is allocated to the projector with the PJ4 ID. The control part of the main projector reads the image data on the projection image allocated to the sub projector from the image memory part 19 in accordance with the table and transmits the image data by the transmission part through the USB I/F 12 (step 28). When the control part of the main projector detects that the sub projectors are not connected to the main projector (step S25: No), the control part of the main projector advances the processing to step S29. The control part of the main projector reads the projection image allocated to the own projector from the image memory part 19, and transmits the projection image to the image processing circuit 22 for projection of the projection image (step S29).

Next, the control part of the main projector, after executing the pointer processing (step S30), acquires instruction information from the pointer PT and executes table rewriting processing (step S31). The control part of the main projector detects the finishing of the processing from the control panel 20 (step S32: Yes), and finishes the processing. When the control part of the main projector does not detect the finishing of the processing (step S32: No), the control part of the main projector returns the processing to step S23.

In step S21, when the control part of the projector detects that the projector is not connected to the PC (step S21: No), the control part detects whether or not the projector is connected to the main projector (step S33) (see FIG. 16B). When the control part of the projector detects that the projector is connected to the main projector (step S33: Yes), the control part of the projector sets own projector as the sub projector (step S34). The control part of the sub projector transmits the ID which is the identification information on the own projector to the main projector through the transmission part, and receives the image data on the projection image from the main projector through the reception part (step S35). The control part of the sub projector transmits the received image data to the image processing circuit 22 thus projecting the projection image based on the image data on the projection surface (step S36). Then, after the pointer processing (step S37) is executed, when the control part of the sub projector detects the finishing of the processing from the control panel 20 (step S38: Yes), the control part of the sub projector finishes the processing. When the control part of the sub projector does not detect the finishing of the processing from the control panel 20 (step S38: No), the control part of the sub projector returns the processing to step S35, and waits for the reception of image data from the main projector.

### <Operation Flow of Pointer Processing (Processing of Whole Screen)>

FIG. 18 is a flowchart showing an operation mode of pointer processing. This pointer processing is in common with the pointer processing executed in step S30 and step S37. Accordingly, the processing executed in step S30 is processing for the main projector, while the processing executed in step S37 is processing for the sub projectors. Hereinafter, the main projector and the sub projector are simply referred to as “projector”. The projection image imaging part 15 of the projector images the projection image to be projected onto the projection surface of the own projector (step S41). When the spot light detection part of the projector detects the spot light from the imaged data (step S42: Yes), the instruction information generation part discriminates the pushed instruction button of the pointer PT by demodulating the detected spot light thus generating the instruction information (step S43). When the projector is the sub projector, the control part of the sub projector transmits the processing information consisting of the generated instruction information and the ID of the sub projector to the main projector (step S44). When the projector is the main projector, the control part of the main projector stores the processing information in the RAM 17.

When necessary, the position detection part of the projector detects a position to which a spot light is radiated based on imaged data, and generates positional information.

Then, the position detection part of the projector adds the positional information to the processing information, and transmits the processing information to the main projector.

This is because, for example, as shown in FIG. 10A to FIG. 13D, such positional information becomes necessary in detecting the instruction information based on a position of the spot light.

### <Flow of Table Rewriting Processing>

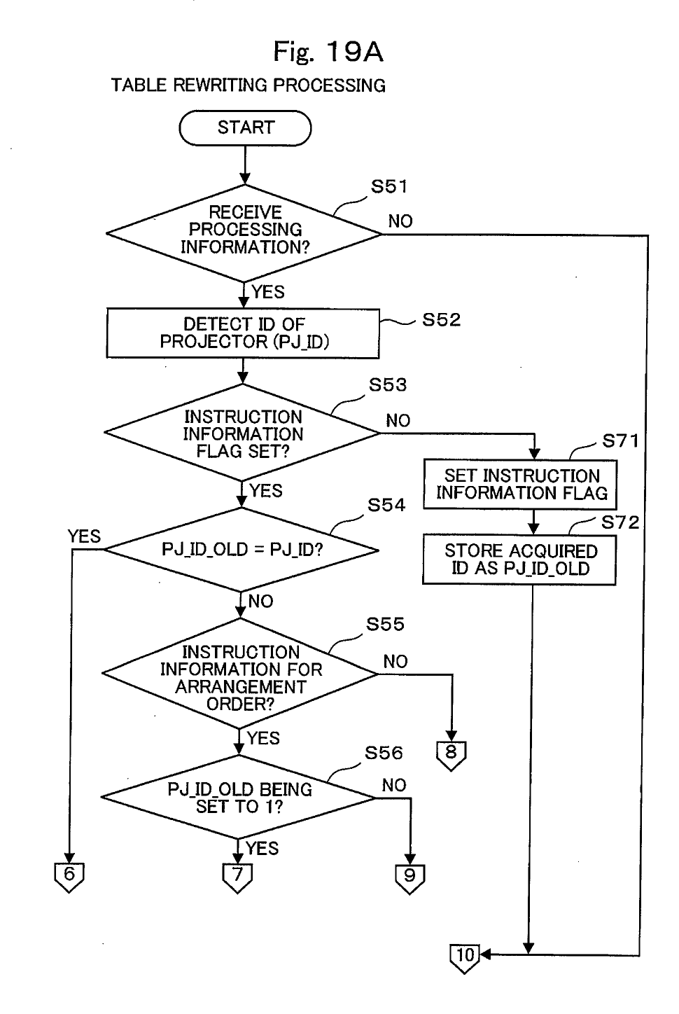

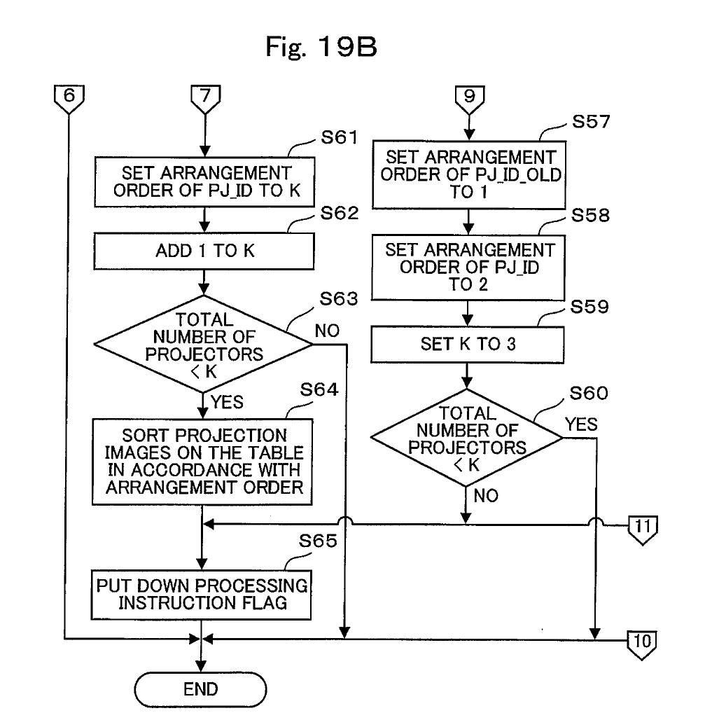

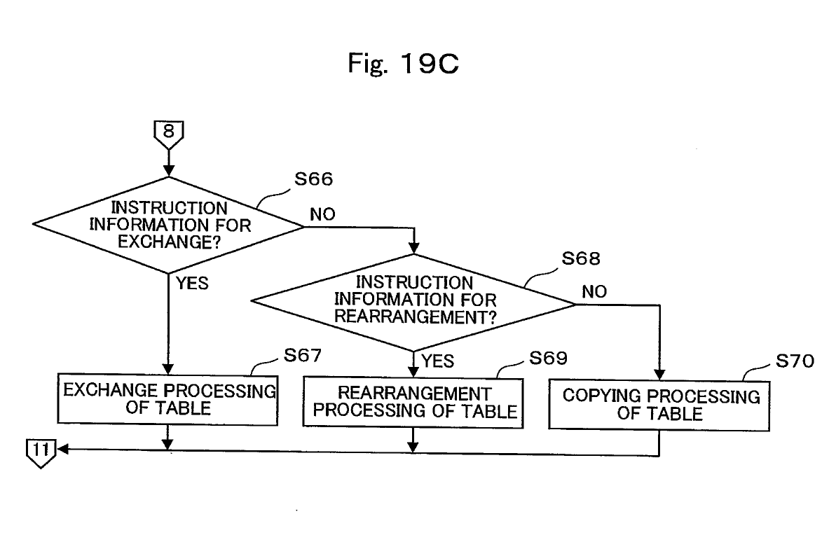

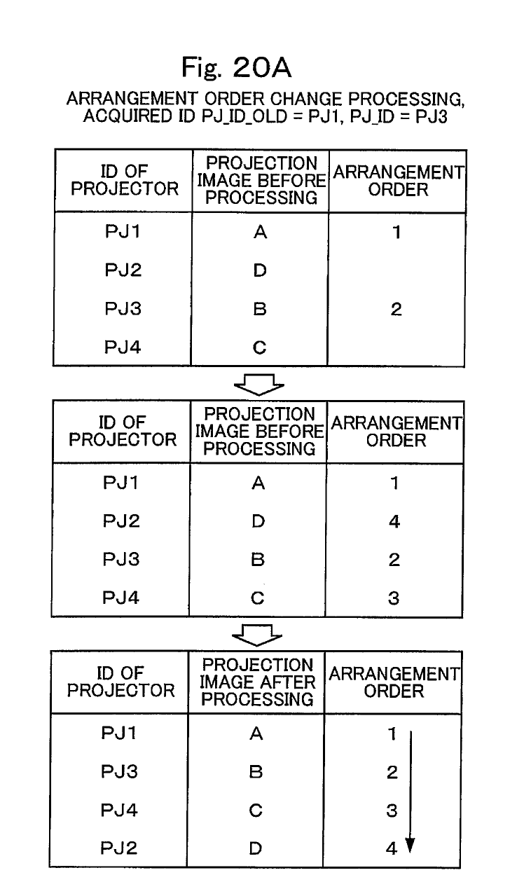

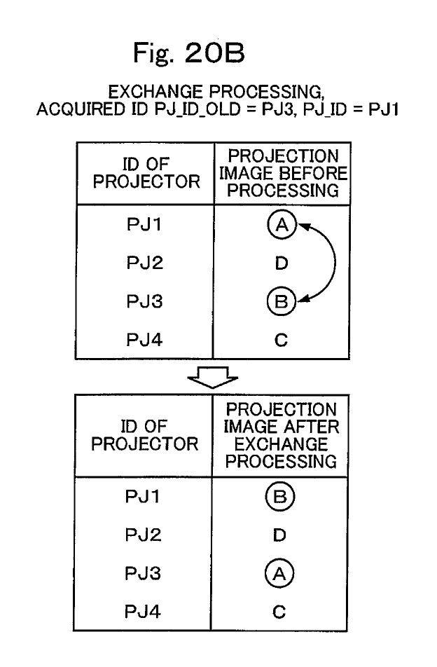

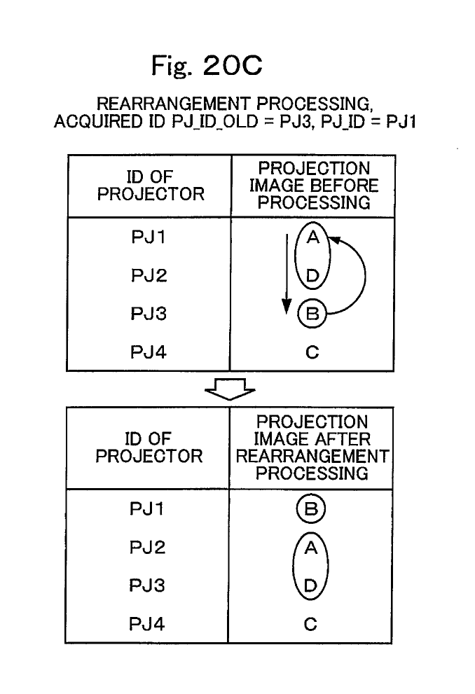

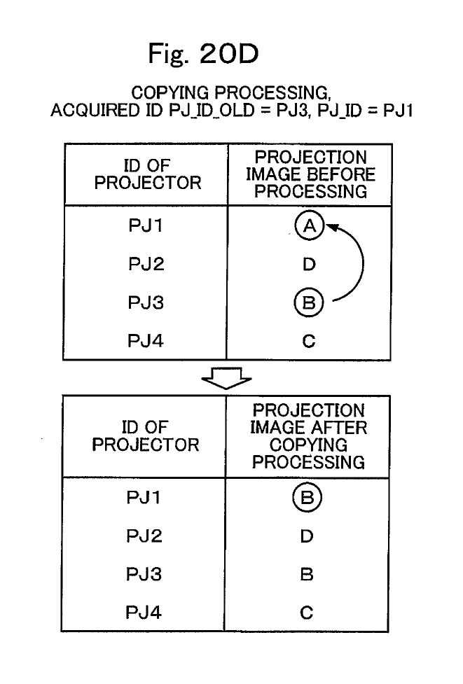

FIG. 19A to FIG. 19C are flowcharts showing an operation mode of table rewriting processing of the main projector. FIG. 20A to FIG. 20D show a change of set values on the tables in respective processings before and after table rewriting. FIG. 20A shows arrangement order change processing, FIG. 20B shows exchange processing, FIG. 20C shows rearrangement processing, and FIG. 20D shows copying processing. In FIG. 20A to FIG. 20D, a left table shows a set state before processing, while a right table shows a set state after processing.

As shown in FIG. 19A, when the control part of the main projector receives the processing information from the sub projector (step S51: Yes), the control part of the main projector detects the ID from the processing information, and stores the ID as PJ_ID (step S52). The control part of the main projector determines whether or not an instruction information flag which assumes an ON state when the control part of the main projector acquires instruction information from the sub projector or the main projector is set (step S53). When the control part of the main projector determines that the instruction information flag is already set (step S53: Yes), the control part of the main projector determines whether or not PJ_ID_OLD which is the ID of the projector to which an instruction information flag is set and PJ_ID which is the ID of the projector which transmits the instruction information received immediately before agree with each other (step S54).

When the control part of the main projector determines that PJ_ID_OLD and PJ_ID do not agree with each other (step S54: No), the control part of the main projector reads the instruction information from the processing information stored in the RAM 17, and determines whether or not the instruction information is instruction information for changing the arrangement order (step S55). When the control part of the main projector determines that PJ_ID_OLD and PJ_ID agree with each other (step S54: Yes), the ID agreement determination processing is finished. A state where PJ_ID_OLD and PJ_ID agree with each other implies that designation processing is executed plural times on the same projection surface using the pointer PT, and this step is provided for skipping the designation processing.

When the control part of the main projector determines that the instruction information flag is not set (step S53: No), the control part of the main projector sets instruction information flag (step S71), and sets and stores an acquired ID as PJ_ID_OLD. That is, the projector whose ID is set as PJ_ID_OLD is the projector where the instruction information is generated previously by the pointer PT.

### <<Arrangement Order Change Processing>>

When the control part of the main projector determines that the instruction information is instruction information for changing the arrangement order (step S55: Yes), the control part of the main projector determines whether or not the PJ_ID_OLD is set to 1 (step S56). When the control part of the main projector determines that the PJ_ID_OLD is not set to 1 (step S56: No), the control part of the main projector sets the arrangement order of PJ_ID_OLD to 1 (step S57) (see FIG. 19B), sets the arrangement order of PJ_ID to 2 (step S58), and writes the arrangement order in the table.

A left side table shown in FIG. 20A shows a state where this arrangement order is written. Here, assume PJ_ID_OLD as the ID of the projector PJ1, and PJ_ID as the ID of the projector PJ3. The control part of the main projector sets K which is a value for designating the arrangement order of the projection images to 3 (step S59). When K is larger than the total number of the projectors connected to each other (step S60: Yes), the control part of the main projector finishes the designation processing, while when the K is smaller than the total number of the projectors connected to each other (step S60: No), the control part of the main projector advances the processing to step S65. The state where the K is larger than the total number of the projectors implies that no remaining projectors are present for designating the arrangement order, while the state where the K is smaller than the total number of the projectors implies that the projector or the projectors whose arrangement order is not still designated are present.

Next, when the control part of the main projector determines that the arrangement order of PJ_ID_OLD is set to 1 in step S56 (step S56: Yes), the control part of the main projector sets the arrangement order of PJ_ID in table to K (step S61), adds 1 to K (step S62), and determines whether or not K is larger than the total number of projectors (step S63). When the control part of the main projector determines that K is smaller than the total number of projectors (step S63: No), the control part of the main projector returns the processing to step S23 and repeats the above-mentioned processing until the value of K becomes larger than the total number of the projectors. That is, a user designates the arrangement order of the projection images by radiating a laser beam from the pointer PT to projection surfaces on which the respective projectors project images. A state of the table when the arrangement order of all projection images is designated is shown at the center of FIG. 20A. When the control part of the main projector determines that K is larger than the total number of the projectors (step S63: Yes), the control part of the main projector sorts the projection images on the table in accordance with the arrangement order (step S64), and writes the projection images in the table. A state of the table after the processing is shown on a right side of FIG. 20A. The control part of the main projector transmits image data on the projection image allocated to the projector corresponding to each ID based on the table where the arrangement order is designated. Next, the control part of the main projector puts down the processing instruction flag (step S65), and finishes the arrangement order processing.

### <<Exchange Processing>>

Next, as shown in FIG. 19A, when the control part of the main projector determines that the instruction information does not instruct the arrangement order change (step S55: No) and the instruction information instructs exchange processing (step S66: Yes) (see FIG. 19C), the control part of the main projector executes exchange processing of the table (step S67). A state of the table before the exchange processing is shown on a left side of FIG. 20B, and the table after the exchange processing is shown on a right side of FIG. 20B. The projector PJ3 (PJ_ID_OLD) is firstly designated, and the projector PJ1 (PJ_ID) is designated next. The control part of the main projector moves a projection image of the projector PJ1 to the projector PJ3, and moves a projection image of the projector PJ3 to the projector PJ1. The control part of the main projector transmits image data on the projection images to the respective projectors based on the table after the exchange processing.

Next, the control part of the main projector advances the processing to step S65, and finishes the exchange processing by putting down the instruction information flag.

<<Rearrangement processing>>

When the control part of the main projector determines that the instruction information does not instruct the exchange processing (step S66: No) and the instruction information instructs rearrangement processing (step S68: Yes), the control part of the main projector executes the rearrangement processing of the table (step S69). A state of the table before the rearrangement processing is shown on a left side of FIG. 20C, and a state of the table after the rearrangement processing is shown on a right side of FIG. 20C. The projector PJ3 (PJ_ID_OLD) is firstly designated, and the projector PJ1 (PJ_ID) is designated next. The control part of the main projector moves a projection image of the projector PJ3 to the projector PJ1, moves a projection image of the projector PJ1 to the projector PJ2, and moves a projection image of the projector PJ2 to the projector PJ3. The control part of the main projector transmits image data on projection images to the respective projectors based on the table after the rearrangement processing. Next, the control part of the main projector advances the processing to step S65, and finishes the rearrangement processing by putting down the instruction information flag.

### <<Copying Processing>>

When the control part of the main projector determines that the instruction information does not instruct the rearrangement processing (step S68: No), the control part of the main projector executes the copying processing of the table (step S70). A state of the table before the copying processing is shown on a left side of FIG. 20D, and a state of the table after the copying processing is shown on a right side of FIG. 20D. The projector PJ3 (PJ_ID_OLD) is firstly designated, and the projector PJ1 (PJ_ID) is designated next. The control part of the main projector copies a projection image of the projector PJ3 to the projector PJ1. The control part of the main projector transmits image data on projection images to the respective projectors based on the table after the rearrangement processing. Next, the control part of the main projector advances the processing to step S65, and finishes the copying processing by putting down the instruction information flag.

In the above-mentioned respective processing, the control part of the main projector flickers the projection image which the projector in which the instruction information is generated firstly projects. For example, in step S72, the control part of the main projector sets image data on the projection image which is transmitted to the projector whose ID is set to PJ_ID_OLD to flicker. A user can recognize the designation using the pointer PT due to flickering of the projection image.

### <Operation Flow of Projector (Processing of Object)>>

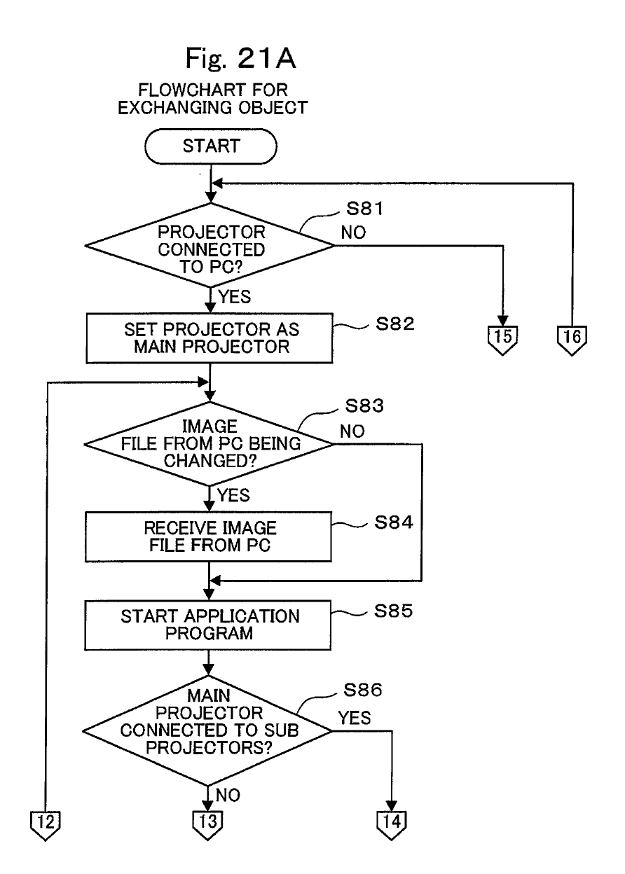

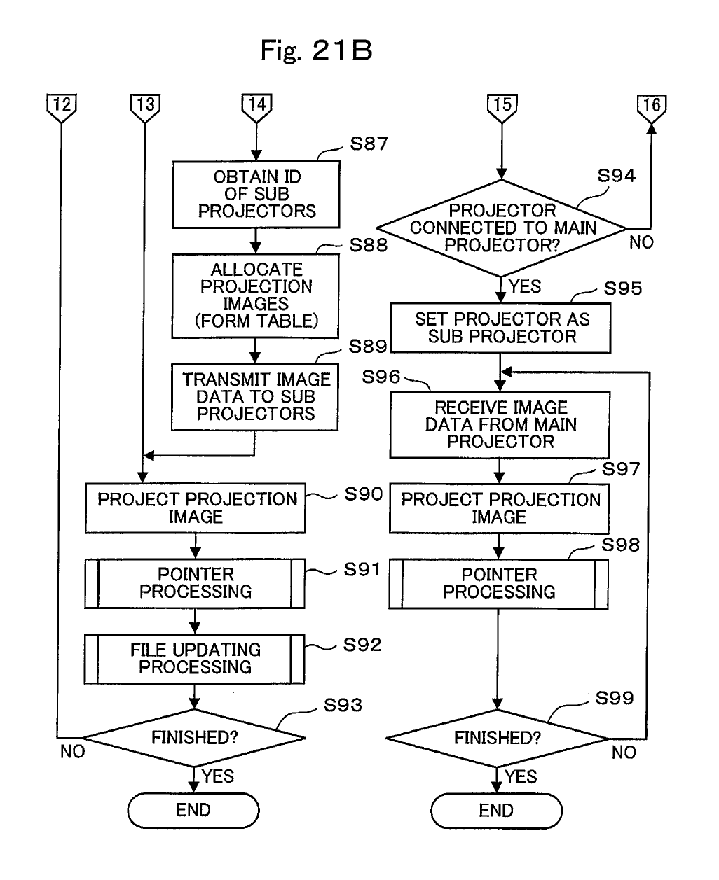

FIG. 21A to FIG. 21B are flowcharts showing an operation mode in which processing such as exchange processing is executed in terms of an object on a projection image. With respect to respective processing steps described hereinafter, steps which differ from the steps shown in FIG. 16A to FIG. 16B are mainly explained, and the detailed explanation of the same steps is omitted.

As shown in FIG. 21A, when the projector is connected to the PC (step S81), such a projector is set as the main projector (step S82). When an image file is already stored in the image memory part 19, the control part of the main projector determines whether or not an image file acquired from the PC is changed (step S83). When the control part of the main projector determines that the image file acquired from the PC is changed (step S83: Yes), the control part of the main projector receives the image file from the PC and stores the image file in the image memory part 19 (step S84), and starts an application program of the image file (step S85).

The processings which are executed after the above-mentioned processing are equal to the corresponding processings (steps S25 to S38) described in FIG. 16A to FIG. 16B and hence, the explanation of these processings is omitted. These processings are constituted of the processing for determining the connection with the sub projectors (step S86), the processing for acquiring IDs from the sub projectors (step S87), the image allocation processing (step S88), the processing for transmitting image data to the sub projectors (step S89), image projection processing (step S90), finishing determination processing (step S93), processing for confirming the connection with the main projector (step S94), sub projector setting processing (step S95), the processing for receiving image data from the main projector (step S96), the image projection processing (step S97), and the finishing determination processing (step S99).

### <Operation Flow of Pointer Processing (Processing of Object)>

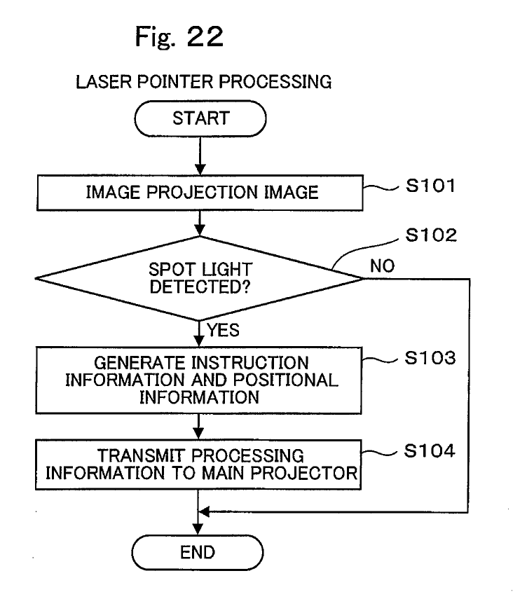

FIG. 22 is a flowchart showing an operation mode of the pointer processing. This pointer processing is in common with the pointer processing executed in step S91 and step S98. The projection image imaging part 15 of the projector images a projection image on the projection surface which the own projector projects (step S101). When a spot light detection part of the projector detects a spot light from the image data (step S102: Yes), the instruction information generation part discriminates the pushed instruction button of the pointer PT by modulating the detected spot light thus generating the instruction information, and the positional information generation part generates positional information by detecting a position of the spot light from the imaged image data (step S103). When the projector is the sub projector, the control part of the projector transmits the processing information consisting of the generated instruction information, the generated positional information and the ID of the projector to the main projector (step S104). When the projector is the main projector, the control part of the projector stores the processing information in the RAM 17.

### <File Updating Processing Flow (Processing of Object)>

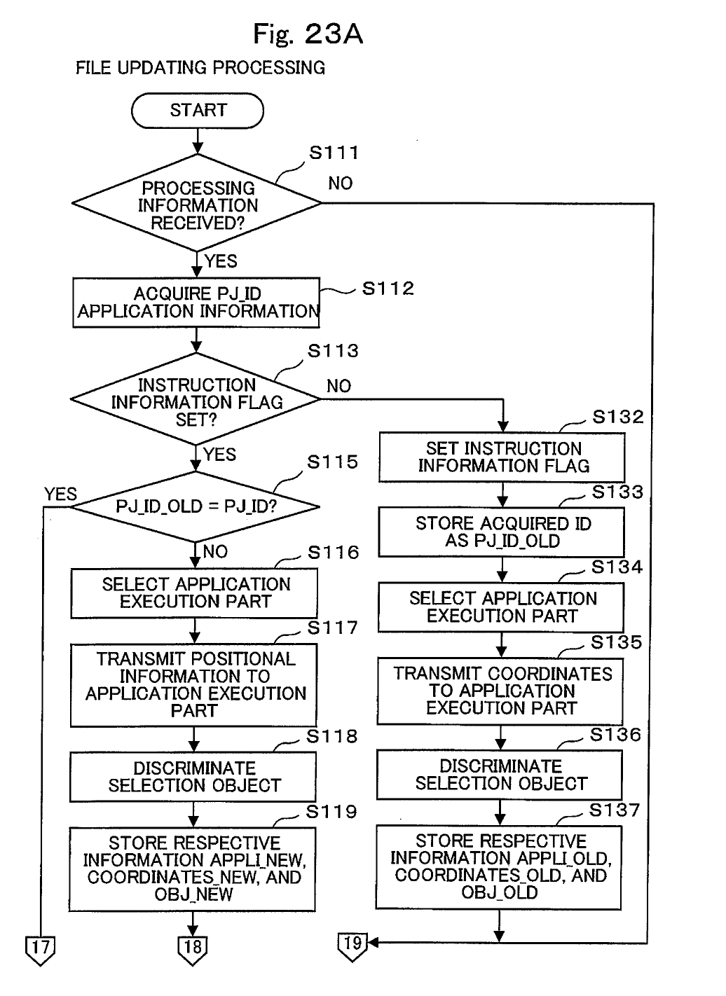

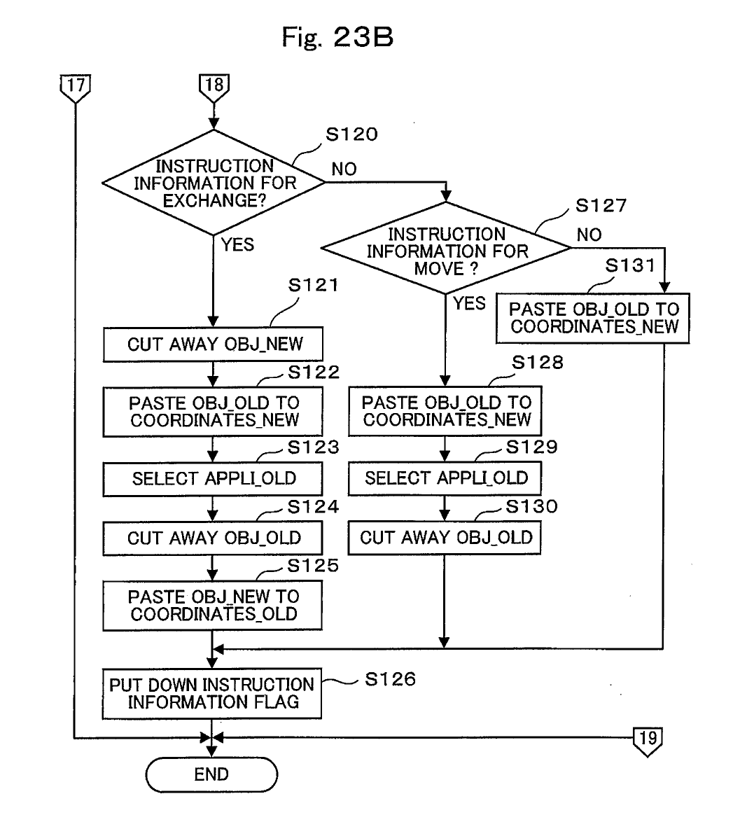

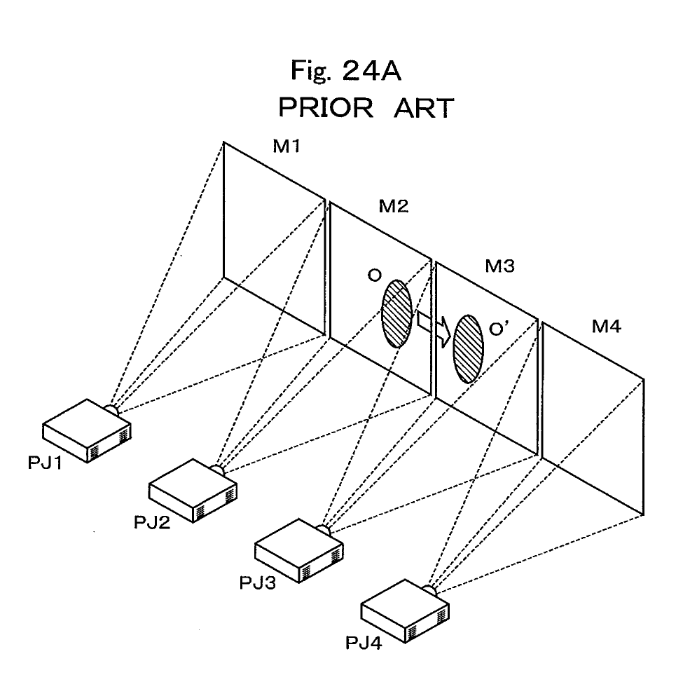

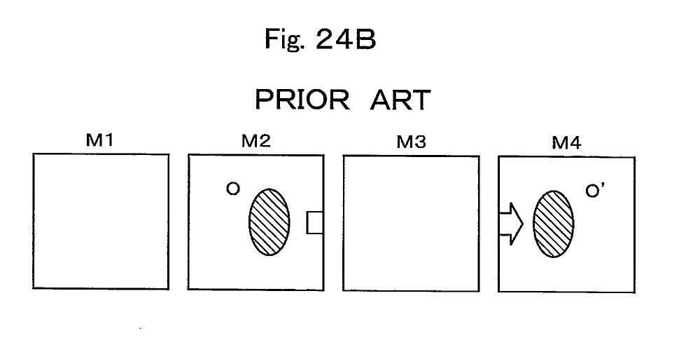

FIG. 23A to FIG. 23B are flowcharts showing an operation mode of file updating processing executed in step S92.

As shown in FIG. 23A, when the control part of the main projector determines that the processing information is received from the sub projector or the processing information is generated by the own main projector (step S111: Yes), the control part of the main projector acquires the ID of the received or generated projector and sets the ID to the PJ_ID, and acquires application information on image data which the projector projects (step S112). Next, when the control part of the main projector determines that an instruction information flag which is set when the instruction information is firstly acquired is set (step S113: Yes), the control part of the main projector determines whether or not PJ_ID_OLD which indicates the projector which transmits the instruction information firstly and PJ_ID which indicates the projector which transmits the instruction information immediately before agree with each other (step S115). When PJ_ID_OLD and PJ_ID agree with each other (step S115: Yes), the control part of the main projector finishes the processing. When PJ_ID_OLD and PJ_ID do not agree with each other (step S115: No), the control part of the main projector selects the application execution part of the projector having PJ_ID (step S116). The control part of the main projector transmits acquired positional information to the application execution part (step S117), and the object specifying part discriminates a selection object selected by the pointer PT (step S118). The control part of the main projector stores the application execution part as APPLI_NEW, the positional information as COORDINATES_NEW, and the selection object as OBJ_NEW in the RAM 17 (step S119). When the control part of the main projector determines that the instruction information flag is not set (step S113: No), the control part of the main projector sets instruction information flag (step S132), stores an acquired ID as PJ_ID_OLD in the RAM 17 (step in S133), selects the application execution part which the projector projects (step S134), and transmits the positional information contained in the processing information to the application execution part (step S135). The object specifying part of the application execution part discriminates the selection object specified based on the positional information (step S136). The control part of the main projector stores the application execution part as APPLI_OLD, the positional information as COORDINATES_OLD, and the selection object as OBJ_OLD in the RAM 17 (step S137).

### <<Exchange Processing of Object>>

As shown in FIG. 23B, When the control part of the main projector determines that the instruction information instructs the exchange processing for exchanging an object (step S120: Yes), the image data processing part of the application execution part APPLI_NEW cuts away the object OBJ_NEW from image data which the application executes (step S121), and pastes object OBJ_OLD to a position of COORDINATES_NEW (step S122). The control part of the main projector selects the application execution part APPLI_OLD (step S123), and the image data processing part of the application execution part cuts away the object OBJ_OLD from the image data (step S124), and pastes the object OBJ_NEWₜₒ the position COORDINATES_OLD (step S125). Accordingly, the object of the firstly selected projection image is exchanged with the object of the later selected projection image.

### <<Movement Processing of Object>>

When the control part of the main projector determines that the instruction information does not instruct the exchange processing (step S120: NO), the control part of the main projector makes the determination of the movement processing in which the object is moved based on the instruction information (step S127). When the control part of the main projector determines that the instruction information instructs the movement processing (step S127: Yes), and the image data processing part of the application execution part APPLI_NEW pastes the object OBJ_OLD to COORDINATES_NEW of image data which the application executes (step S128). The control part of the main projector selects the application execution part APPLI_OLD (step S129), and the image data processing part of the application execution part APPLI_OLD cuts away the object OBJ_OLD from the image data which the application executes (step S130). Then, the control part of the main projector puts down the instruction information flag (step S126) and finishes the processing. Accordingly, the object of the firstly selected projection image is moved to the later selected projection image. Here, the position of the object of the movement destination can be set as the position of the COORDINATES_NEW.

### <<Copying Processing of Object>>

When the control part of the main projector determines that the instruction information does not instruct the movement processing (step S127: No), the image data processing part of the application execution part APPLI_NEW pastes the object OBJ_OLD to the position COORDINATES_NEW of image data which the application executes (step S131). Accordingly, the object OBJ_OLD of the firstly selected projection image is copied to the later selected projection image.

In the above-mentioned object processing flow, when the firstly selected application execution part and the later selected application execution part are formed of the same application execution part, it is unnecessary to discriminate APPLI_OLD and APPLI_NEW from each other. Further, in each processing, the control part of the main projector can flicker the selected object in the projection image which the projector in which the instruction information is firstly generated projects. For example, in step S136, the control part of the main projector sets the object OBJ_OLD in the image data on the projection image which is transmitted to the projector set to PJ_ID_OLD to flicker. A user can confirm the designation of the object by the pointer PT based on flickering of the selected object.

In the above-mentioned operation mode of the operation flow of the pointer and the projectors, the explanation has been made with respect to the method which transmits the instructions to the projector using a modulated laser beam by a pointer. However, the present invention is not limited to such a method. The pointer and the projectors may be operated such that an infrared ray emission part is provided to the pointer PT, an infrared ray reception part is provided to each projector, and the instructions may be transmitted to each projector with the infrared ray when each button of the pointer is pushed. Further, the pointer and the projectors may be operated such that a processing instructions screen is projected to the projection image of each projector, and a laser beam of the pointer PT is projected onto the processing instructions screen thus allowing each projector to discriminate the instructions by the projected spot light.

Further, the explanation has been made with respect to the case where the main projector collectively controls the image data processing. However, the projector system of the present invention is not limited to such a case. Each projector may start the application program of the projection image, and the image processing may be executed for every projector. For example, with respect to two sets of projectors, when the projection image which one set of projector projects and the projection image which the other set of projector projects are exchanged with each other wholly or partially, the copying source projector allows the instruction information generation part to generate instruction information and allows the position detection part to detect the position of the spot light. Simultaneously, based on the instruction information and the positional information, the image data processing part specifies the image data on the designated exchange image, and transmits the specified exchange image data to the exchange destination based on the notification from the exchange destination projector. Simultaneously, the image data to be exchanged may be received from the exchange destination projector, and the projection images which two sets of projectors project may be exchanged. In this case, a data amount of transmitted/received image data can be decreased between both projectors and hence, it is possible to acquire an advantageous effect that the projection images can be changed at a high speed.

To summarize the above, it is sufficient for the present invention that one projector detects a spot light from the pointer PT and transmits the processing information to the other projector, the other projector detects a spot light from the pointer PT, and the whole or a part of the projection image which either one of the projectors projects is projected by the other projector.

What is claimed is:

1. A projector system comprising:
a plurality of projectors which are configured to be communicable with each other; and
a pointer which is configured, by radiating a spot light to a projection area onto which a projection image is projected using the projector, to give an instruction relating to processing of the projection image; wherein
the projector includes:
a spot light detection part which is configured to detect the spot light radiated to the projection area of the projector;
an instruction information generation part which is configured to generate instruction information relating to processing of the projection image based on a detected spot light; and
a transmission part which is configured to transmit processing information which contains the instruction information and identification information for specifying the projector, wherein
when one projector detects the spot light and, thereafter, another projector detects the spot light, a whole or a part of the projection image which said one projector projects is projected by said another projector based on the processing information.

2. A projector system according to claim 1, wherein the pointer is configured to give an instruction relating to processing of the projection image based a modulated spot light formed by modulating the spot light, and the instruction information generation part of the projector is configured to generate the instruction information by demodulating the instruction based on the modulated spot light detected by the spot light detection part.

3. A projector system according to claim 1, wherein the pointer further includes an infrared ray generation part which is configured to emit an infrared ray for giving an instruction relating to the processing of the projection image, and the projector further includes an infrared ray reception part which is configured to receive the infrared ray emitted from the pointer, and the instruction information generation part is configured to generate the instruction information added with the instruction based on the received infrared ray .

4. A projector system according to claim 1, wherein the projector includes a position detection part which is configured to detect, based on the spot light detected by the spot light detection part, a position of the spot light within the projection area, and is configured to generate positional information for designating a whole or a part of the projection image to be projected.

5. A projector system according to claim 4, wherein the transmission part of the projector is configured to transmit the processing information added with the positional information.

6. A projector system according to claim 4, wherein the instruction information generation part of the projector is configured to generate the instruction information based on the positional information generated by the position detection part.

7. A projector system according to claim 1, wherein when the instruction information generation part of said one projector and the instruction information generation part of said another projector respectively generate the instruction information relating to the processing of the projection image based on the detected spot light, and either one or both of the respective instruction information is an exchange instruction for wholly or partially exchanging the projection image, a whole or a part of the projection image which said one projector projects is exchanged with a whole or a part of the projection image which said another projector projects.

8. A projector system according to claim 1, wherein when the instruction information generation part of said one projector and the instruction information generation part of said another projector generate the instruction information relating to the processing of the projection image based on the detected spot light respectively, and either one or both of the respective instruction information is a copy instruction for wholly or partially copying the projection image, a whole or a part of the projection image which said one projector or said another projector projects is copied to the projection image which said another projector or said one projector projects.

9. A projector system according to claim 1, wherein when the instruction information generation part of said one projector and the instruction information generation part of said another projector respectively generate the instruction information relating to the processing of the projection image based on the detected spot light, and either one or both of the respective instruction information is a move instruction for wholly or partially moving the projection image, a whole or a part of the projection image which said one projector or said another projector projects is moved to the projection image which said another projector or said one projector projects.

10. A projector system according to claim 1, wherein when the instruction information generation part of said one projector and the instruction information generation part of said another projector respectively generate the instruction information relating to the processing of the projection image based on the detected spot light, and either one or both of the respective instruction information is an arrangement order change instruction for changing an arrangement order of the projection images, the projection image projected by said one projector or said another projector is projected by said another projector or said one projector, and the projection images in a preset order are projected from other projectors using said another projector or said one projector as the reference.

11. A projector system according to claim 1, wherein when the instruction information generation part of the plurality of projectors respectively generate instruction information and the respective instruction information is arrangement order designation instruction for designating arrangement order of the projection images, projection images whose order is preliminarily designated are projected from the plurality of projectors in order of projectors which generate the instruction information.

12. A projector system according to claim 1, wherein assuming the projector at the transmission destination of the processing information as a main projector and the projectors other than the main projector as sub projectors,
the main projector includes an image memory part which is configured to store image data on the projection images which the sub projectors project and a reception part which is configured to receive the processing information from the sub projectors, and is configured to transmit the image data to the sub projectors by the transmission part based on the instruction information and the identification information contained in the received processing information, and
the sub projector includes a reception part which is configured to receive the image data from the main projector, and is configured to project the projection image based on the received image data.

13. A projector system according to claim 12, wherein the main projector further includes an object specifying part which is configured to specify an object in a projection image based on positional information and instruction information contained in the processing information, and an image data processing part which is configured to add the specified object to the image data or to erase the specified object from the image data, and the main projector is configured to transmit the image data processed by the image data processing part to the sub projectors by the transmission part.

14. A projector system according to claim 1, wherein said one projector is configured to transmit the image data relating to a whole or a part of the projection image which said one projector projects to said another projector, and said another projector is configured to project a whole or a part of the projection image based on the image data received from said one projector.

15. A driving method of a projector system which includes: a plurality of projectors which are configured to be communicable with each other; and a pointer which is configured , by radiating a spot light to a projection area onto which a projection image is projected using the projector, to give an instruction relating to processing of projection images, the driving method comprising the steps of:
allowing one projector to detect the spot light radiated from the pointer, to generate instruction information relating to processing of the projection image in response to the detection of the spot light from the pointer, and to transmit the processing information; and
allowing another projector to detect the spot light radiated from the pointer, and to project a whole or a part of the projection image which said one projector projects based on the processing information.
